(19) United States
(12) Patent Application Publication
(10) Pub. No.: US 2024/0134769 A1
(43) Pub. Date: Apr. 25, 2024

(54) SYSTEMS AND METHODS FOR AGILE AND EXPLAINABLE OPTIMIZATION OF EFFICIENT HARDWARE/SOFTWARE CODESIGNS FOR DOMAIN-SPECIFIC COMPUTING SYSTEMS USING BOTTLENECK ANALYSIS

(71) Applicants: Arizona Board of Regents on Behalf of Arizona State University, Tempe, AZ (US); University of California, Los Angeles, CA (US)

(72) Inventors: Shail Dave, Tempe, AZ (US); Aviral Shrivastava, Phoenix, AZ (US); Tony Nowatzki, Los Angeles, CA (US)

(21) Appl. No.: 18/485,811

(22) Filed: Oct. 12, 2023

Related U.S. Application Data
(60) Provisional application No. 63/425,810, filed on Nov. 16, 2022.
(60) Provisional application No. 63/415,452, filed on Oct. 12, 2022.

(51) Int. Cl. G06F 11/34; G06F 8/41

(52) U.S. Cl. CPC G06F 11/3428; G06F 8/4441

(57) ABSTRACT

A system applies bottleneck analysis for design and optimization of computing systems. In particular, the system constructs a bottleneck model, including a bottleneck cost graph for a workload or a function, through which factors corresponding to the execution costs of an arbitrary processor can be modeled. By using the bottleneck analysis, the system can determine bottleneck factors for an obtained cost value (e.g., time taken by an application's execution on a processor) and can reason about obtained high cost. The system determines and uses information about parameters impacting bottlenecks for execution costs and their approximate relationship with the bottlenecks to produce an optimized hardware-software configuration for execution of one or more workloads. Systematic, bottleneck-guided analysis and optimization can introduce explainability in the design and optimization process and can achieve more efficient design configurations much faster.

### CROSS-REFERENCE TO RELATED APPLICATIONS

This is a U.S. Non-Provisional Patent Application that claims benefit to U.S. Provisional Patent Application Ser. No. 63/415,452 filed 12 Oct. 2022, and U.S. Provisional Patent Application Ser. No. 63/425,810 filed 16 Nov. 2022, which are herein incorporated by reference in their entirety.

### GOVERNMENT SUPPORT

This invention was made with government support under 1645578 awarded by the National Science Foundation. The government has certain rights in the invention.

### FIELD

The present disclosure generally relates to computing system design optimization, and in particular, to a system and associated method for bottleneck analysis for achieving explainability and bottleneck-mitigating optimization for the computing systems design.

### BACKGROUND

Explainability of computing system configurations, especially of modern processors, is required to be able to design and use them effectively. Current mechanisms for designing computing systems and characterizing the costs of execution of a workload on these systems are non-explainable. For instance, running a simulation of a workload execution does not explain why a hardware/software configuration of a processor takes a particular amount of time (or energy or chip area) to process the application. This slows down the productivity of the users, e.g., computing system designers. Likewise, existing methods for optimizing the computing system design explore numerous configurations, without ever reasoning about why a certain configuration could lead to a certain execution cost. As a result, obtained configurations after optimizations are not just less efficient (sometimes even several-fold), but also take a long amount of time, as most of the explored configurations during optimizations are random trials, without solid reasoning. They also cannot explain why their obtained solutions are the optimal ones, when establishing the optimality is infeasible due to a vast search space of solutions (e.g., quadrillion solutions).

It is with these observations in mind, among others, that various aspects of the present disclosure were conceived and developed.

### BRIEF DESCRIPTION OF THE DRAWINGS

FIGS. 1A-1D are a series of simplified block diagrams showing various design space exploration (DSE) frameworks;

FIG. 2 is a simplified diagram showing an example bottleneck graph of a bottleneck model for deep neural network (DNN) accelerator latency;

FIGS. 3A-3C are a series of graphical representation showing efficiency, feasibility, and agility of explainable and non-explainable DSE frameworks;

FIG. 4 is a diagram showing a problem formulation for development of an Explainable-DSE framework outlined herein;

FIGS. 5A and 5B are a pair of graphical representations showing processing element quantity and shared memory sizes achieved with prior techniques compared with that of the Explainable-DSE framework outlined herein;

FIG. 6 is a simplified diagram showing the Explainable-DSE framework outlined herein;

FIGS. 7A-7E are a series of illustrations showing a walkthrough example of the Explainable-DSE framework outlined herein applied to a DNN accelerator;

FIGS. 8A-8C are a series of conceptual diagrams showing an API through which designers can specify a bottleneck model of a system for optimization using the Explainable-DSE framework outlined herein;

FIG. 9 is a simplified diagram showing a bottleneck cost graph based on a bottleneck model applied in the context of latency of a DNN layer execution of a DNN accelerator;

FIG. 10 is a graphical representation showing latency results for various DSE techniques for static exploration, where (A) Grid Search, (B) Random Search, (C) Simulated Annealing, (D) Genetic Algorithm, (E) Bayesian Optimization, (F) Hypermapper 2.0 (based on Bayesian optimization), (G) Reinforcement Learning, (H) Explainable-DSE with Fixed dataflow, (I) Random search Codesign, (J) Hypermapper 2.0 Codesign, and (K) Explainable-DSE Codesign;

FIG. 11 is a graphical representation showing total time taken for various DSE techniques for static exploration, where (A) Grid Search, (B) Random Search, (C) Simulated Annealing, (D) Genetic Algorithm, (E) Bayesian Optimization, (F) Hypermapper 2.0 (based on Bayesian optimization), (G) Reinforcement Learning, (H) Explainable-DSE with Fixed dataflow, (I) Random search Codesign, (J) Hypermapper 2.0 Codesign, and (K) Explainable-DSE Codesign;

FIGS. 12A and 12B are a pair of graphical representations showing latency over iterations for various DSE techniques for Computer Vision and Language Processing workloads;

FIG. 13 is a graphical representation showing feasible solution exploration across various DSE techniques;

FIG. 14 is a simplified diagram showing an exemplary computing system for implementation of the Explainable-DSE framework of FIG. 6.

Corresponding reference characters indicate corresponding elements among the view of the drawings. The headings used in the figures do not limit the scope of the claims.

### DETAILED DESCRIPTION

### 1. INTRODUCTION

Domain-specific accelerators, e.g., for deep learning models, are deployed from datacenters to edge. In order to meet strict constraints on execution costs (e.g., power and area) while minimizing an objective (e.g., latency), their hardware/software codesigns must be effectively explored using an effective design space exploration (DSE). However, the search space is vast, and it can include O(10²⁹) solutions, with each evaluation taking milliseconds—minutes. For instance, one work showed that a TPU-like architecture has 10¹⁴ hardware solutions with modest options for design parameters. For every hardware configuration, software space can also be huge. For example, DNN layers can be mapped on a spatial architecture in O(10¹⁵) ways aka dataflows. A “feasible” solution meets all constraints, and its hardware and software configurations are compatible. An “efficient” solution minimizes objective. “Agility” refers to DSE's ability to find desired solutions quickly, which becomes crucial for exploring vast space in practical DSE budgets and runtime DSEs. Clearly, an effective exploration is needed to achieve feasible and efficient solutions quickly.

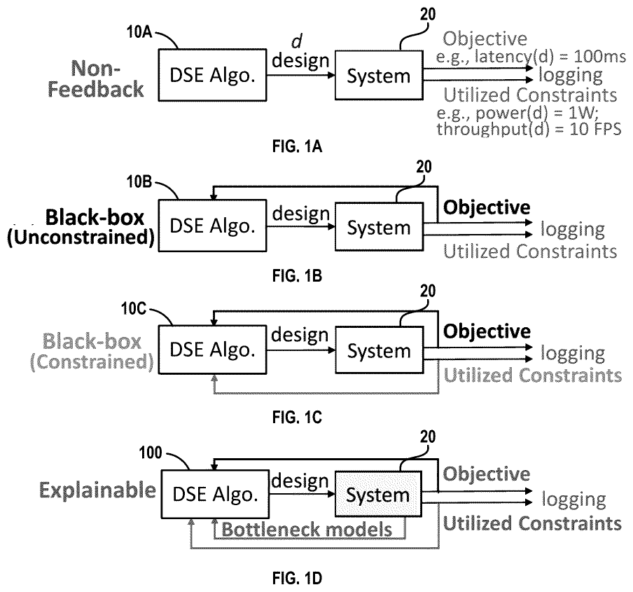

Recent DSE techniques for deep learning accelerators use either non-feedback or black-box optimizations. Non-feedback optimizations include grid search and random search. As depicted in FIG. 1A, a non-feedback DSE framework 10A evaluates different solutions for a system 20 for a pre-set number of iterations and terminate. In Black-box optimizations, as shown in FIGS. 1B and 1C, a black-box DSE framework 10B (or a constrained black-box framework DSE 10C) considers the value of objective before acquiring the next candidates for the solution to be applied to the system 20. (Acquisition refers to a step in a DSE algorithm that selects next set of candidate designs to evaluate. § 3.1 discusses terminology for the DSE techniques.) Thus, they can be more effective than non-feedback approaches. These include simulated annealing, genetic algorithm, Bayesian optimization, and reinforcement learning. These optimizations can be unconstrained (as in FIG. 1B) or constrained (as in FIG. 1C).

For vast accelerator hardware/software codesign space, existing techniques require excessive trials for convergence or even finding a feasible solution. It is believed that this is because of lack of explainability during the exploration. Explainability of a DSE technique refers to its ability to reason about, at each acquisition attempt, why a certain design corresponds to specific costs, and what are underlying inefficiencies, and how they can be ameliorated. Existing exploration techniques are non-explainable as in they lack information and reasoning about the quality of designs acquired during DSE. They may figure out which of the previous trials reduced the objective but they cannot determine why. In contrast, an explainable DSE framework 100 shown in FIG. 1D would identify the inefficiencies of the acquired design that incur high costs and also estimate mitigation requirements that would further improve designs and execution of a workload by the system 20. For instance, in reducing the latency of a DNN accelerator, an explainable DSE could reason that the latency is dominated by memory access time that cannot be hidden behind the time for computation or communicating data on-chip. Therefore, it could strive to reduce latency further by increasing off-chip bandwidth or on-chip buffer size to exploit available data reuse.

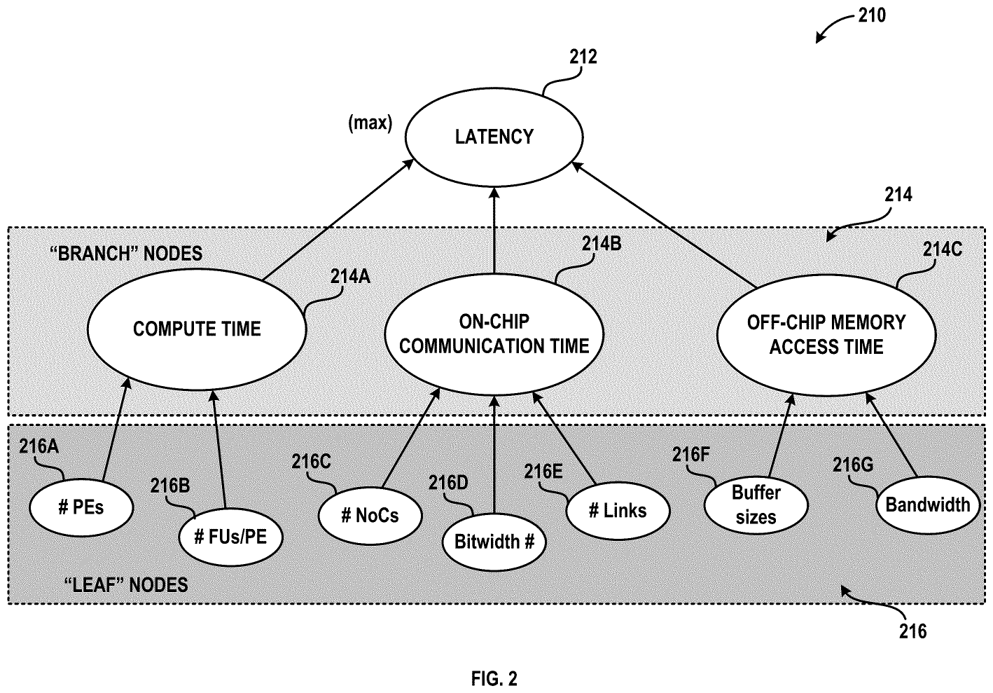

A framework outlined herein, referred to as “Explainable-DSE”, uses bottleneck analysis to enable explainability in DSE, illustrated with a validation example in terms of DNN accelerator/dataflow codesigns. Enabling explainability in DSE with bottleneck analysis requires bottleneck models. Conventional DSE approaches evaluate only cost models in DSE that provide just a single value like latency. In contrast, the domain-specific bottleneck models can provide richer information about how design parameters contribute to various execution factors like the time for computation, memory accesses, and communication via NoCs, which in turn, leads to total cost such as latency. FIG. 2 shows an example bottleneck graph 210 of a bottleneck model for latency. Bottleneck models also provide mitigation strategies, i.e., when one of these factors say on-chip communication gets identified as a bottleneck, how to tune different design parameters based on key execution-related characteristics of the workloads (e.g., increase bit-widths of NoCs by certain amount or increase physical links or time-shared unicast support). These bottleneck models can be developed based on domain-specific information, which is often embedded in experts-defined, domain-specific cost models but implicitly. Having the explicit bottleneck models and their driving the DSE can help DSE explain inefficiencies of acquired designs (referred to as bottleneck analysis) and to make mitigating acquisition decisions.

FIG. 2 shows an example of a bottleneck graph 210, which is a graphical visualization of a bottleneck model expressive of an execution cost hierarchy of a workload or a function of the workload in a graphical format for explicit analysis. The bottleneck graph 210 includes a root node 212 that correlates with a total execution cost associated with the workload or a function of the workload. In the example of FIG. 2, the total execution cost of the root node 212 represents a latency of the system to be optimized (e.g., system 20 shown in FIG. 1D). The bottleneck graph 210 can further include a plurality of “branch” nodes 214, depicted in FIG. 2 as branch nodes 214A-214C which can each represent time values associated with execution by the system that can contribute to the latency represented by the root node 212. Each branch node 214 can be represented by a mathematical operator and can indicate a sub-cost that contributes to the total execution cost at the root node 212. In the example, the latency represented by the root node 212 can be calculated as the maximum of the time values represented by the branch nodes 214A-214C. Further, the bottleneck graph 210 can include a plurality of “leaf” nodes 216, each leaf node 216 representing a value of a design parameter or an execution characteristic that contributes to the sub-cost or the total execution cost. In the example of FIG. 2, the bottleneck graph 210 includes leaf nodes 216A-216G that likewise contribute to the time values represented by the branch nodes 214A-214C. In the example, leaf nodes 216A and 216B contribute to the value associated with branch node 214A, leaf nodes 216C-216E contribute to the value associated with branch node 214B, and leaf nodes 216F-216G contribute to the value associated with branch node 214C. While the example in FIG. 2 is provided in terms of latency with example factors being depicted, the bottleneck graph 210 can be similarly constructed and applied for analysis of different types of values that may be optimized by Explainable-DSE.

For enabling DSE of DNN accelerators using bottleneck analysis, the present disclosure outlines the following:.

1) Validation of “Explainable-DSE” framework using a bottleneck model for deep learning accelerator design domain. Taking latency minimization as an example, the present disclosure describes what execution characteristics of DNN accelerators need to be leveraged, how to construct a corresponding bottleneck model, how its bottleneck graph provides insights in execution inefficiencies of design and how to pinpoint bottlenecks with it, and what are mitigation strategies once a bottleneck is identified. By applying bottleneck analysis on software-optimized executions of each hardware design, the framework for DSE co-explores both hardware-software configurations of DNN accelerators in adaptive and tightly coupled manner.

2) An API for interfacing DSE with domain-specific bottleneck models. Through the API, a bottleneck model of a system to be optimized can be described as a tree corresponding to the target cost. Navigating such tree enables Explainable-DSE to analyze the bottlenecks, relate the bottlenecks with the design parameters, and reason about the desired scaling for mitigations. For instance, by parsing a bottleneck model in the form of a latency tree as in FIG. 2, Explainable-DSE could reason that latency is a maximum value of the time taken for computations, on-chip communications, and memory accesses; if computational time exceed other factors by 3×, then related parameters are number of functional units in PEs and number of PEs, which may need to be scaled next.

The API can allow expert designers to systematically express their domain-specific bottleneck models, similar to the example shown in FIG. 2, and integrate them in Explainable-DSE while leveraging constrained exploration framework. This helps overcome a limitation of previous DSEs using bottleneck analysis in other domains like multimedia or FPGA-HLS which lack such interface; as search mechanisms were defined in domain-specific ways for their bottleneck models, they cannot be decoupled or reused for other domains.

3) “Explainable DSE” framework for constrained DSE using bottleneck models is presented, with acquisitions accounting for multiple bottlenecks in multi-workload executions. Prior frameworks for DSE using bottleneck analysis in other domains optimize only a single task at a time, i.e., consider a single cost value of executing a loop-kernel or a whole task and iteratively mitigate its bottleneck. However, when workloads involve different functions of diverse execution characteristics, e.g., a DNN with multiple layers or multiple DNNs, changing a design parameter impacts their contribution to overall cost in distinct ways; considering just a total cost could not be useful. Also, mitigation strategies to address layer-wise bottlenecks can lead to range of different values for diverse parameters. So, the framework outlined herein systematically aggregates parameters predicted for mitigating bottlenecks in executions of multiple functions in one or more workloads, for making next acquisitions.

Results: The explainable and agile “Explainable-DSE” framework is demonstrated by exploring high-performance edge inference accelerators for recent computer vision and language processing models. By iteratively mitigating bottlenecks, Explainable-DSE reduces latency under constraints in mostly every attempt (1.3× on average). Thus, it explores effectual candidates and achieves efficient codesigns in minutes, while non-explainable optimizations may fail to obtain even a feasible solution over days. Explainable-DSE obtains codesigns of 6× lower latency in (36× less search time on average and up to 1675×) 47× fewer iterations vs. previous DSE approaches for DNN accelerators. By achieving highly efficient solutions in only 54 iterations, Explainable-DSE enables opportunities for cost-effective and dynamic explorations in vast space.

### 2. LIMITATIONS OF PRIOR DNN ACCELERATOR DSES

Non-feedback DSE approaches such as the example in FIG. 1A search either exhaustively over statically reduced space (e.g., grid search) or randomly. So, they do not consider any outputs like objective or utilized constraints and terminate after using a large exploration budget. On the other hand, black-box optimizations such as the examples shown in FIGS. 1A and 1B (e.g., Bayesian Optimization) consider values of objective for previously tried solutions. Considering the objective helps them predict the likelihood of where the minima may lie; they acquire a candidate for the next trial accordingly. The process repeats until convergence or the number of trials exceeding a threshold. While black-box DSE could be more efficient than non-feedback DSE, they all face the following limitations:

Current DSE techniques lack reasoning about bottlenecks incurring high costs: An efficient DSE mechanism should determine challenges hindering the reduction of objectives or utilized constraints. It should also determine which of the many parameters can help mitigate those inefficiencies and with what values. However, with the objective as only input, these black-box or system-oblivious DSEs can figure out only which prior trials reduced the objective. But, they are non-explainable as in they cannot reason about what costs a solution could lead to and why—a crucial aspect in exploring enormous design space. This is exacerbated by the fact that execution characteristics of different functions in workloads are diverse (e.g., memory- vs. compute-bounded DNN operators; energy consumption characteristics). By considering just total cost value, black-box DSEs cannot consider diverse bottlenecks in multi-functional or multi-workload executions that need to be systematically addressed.

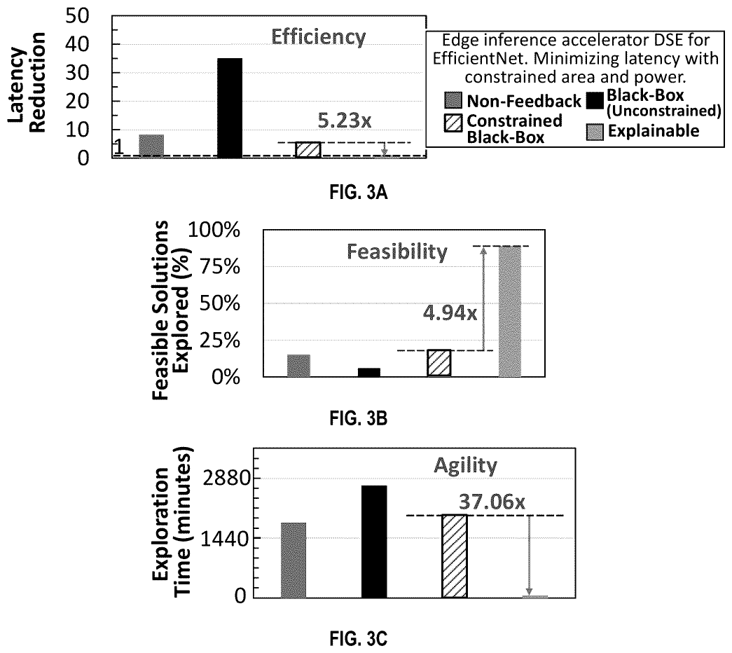

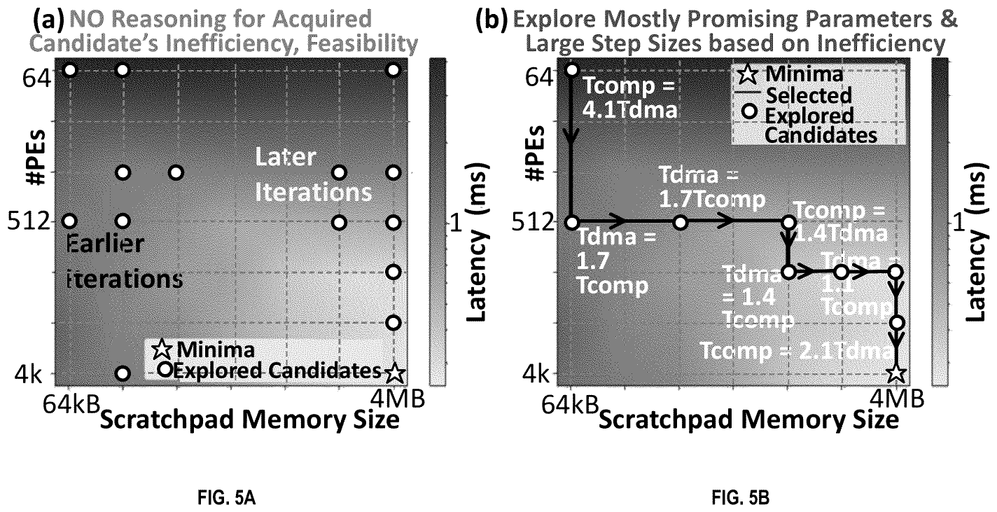

Implications: A major implication of excessive sampling caused by lack of explainability is inefficiency of obtained solutions. FIG. 5A discussed in further detail herein illustrates this through a toy scenario, i.e., exploring the number of PEs and global buffer size for a single ResNet layer. It shows exploration from early iterations to later iterations with HyperMapper 2.0—an efficient, Bayesian-based optimizer. The figure shows that even for a tiny space, acquired solutions are mostly inefficient (high latency), as there is no reasoning about underlying bottlenecks and their mitigation. So, even though DSE has already acquired some better solutions before, later acquisitions correspond to inefficient solutions. As the space becomes vast, the non-explainable DSE techniques can require too many trials (at least, in thousands), and they may still not find the most efficient solutions. As an example, FIG. 3A shows that the latency of the solutions obtained by non-explainable DSEs can be up to 35× higher, even for 2500 trials (two days of search time). This is because practical exploration budget is typically fractional (thousands) compared to the vast design space (quadrillions). By generating trials without understanding executional bottlenecks and their mitigation, most of the search budget gets used for excessive and mostly ineffectual trials.

Lacking reasoning about design's inefficiencies can deprive the DSE of tightly coupled hardware/software codesign. For instance, some DSEs mainly explore architectural parameters with black-box DSEs and use a fixed dataflow for executions (§ 3.2 and § 3.5 provide background on HW/SW codesign DSE process). Fixing the execution methods limit the effectual utilization of architectural resources when subjected to various tensor shapes and functionalities. Consequently, DSEs may achieve architecture designs that are either incompatible with the dataflow (infeasible solutions) or inefficient. Likewise, separate optimizations of architectural design and dataflow that are oblivious of each other can lead to excessive trials and inefficient solutions. Further, for these constrained optimizations, excessive trials are also caused by the fact that DSEs cannot determine which constraints are violated and how configuring different accelerator design parameters could affect that. FIG. 3B illustrates this for an edge accelerator DSE that is subjected to power and area constraints. Out of 2500 solutions evaluated, for constrained optimizations like HyperMapper2.0, only 18% of the all solutions evaluated were feasible and up to only 52% for constrained reinforcement learning.

Another implication of excessive trials is inapplicability to dynamic DSE scenarios. Excessive trials lead to low agility, as illustrated in FIG. 3C. Non-explainable DSEs consume very high exploration time, even weeks, while obtaining solutions of lower efficiency. This makes existing DSE approaches unsuitable for dynamic explorations (e.g., DSE convergence within a few tens to 100 iterations). For instance, unlike one-time ASIC designs, deploying accelerator overlays over FPGAs (edge/cloud; dedicated/multi-tenant) can benefit from dynamic DSEs, where constraints for DSE and resource budget may also become available just before deployment.

### 3. DSE OF DEEP LEARNING ACCELERATORS USING BOTTLENECK ANALYSIS: MOTIVATION AND CHALLENGES

### 3.1. DSE Problem Formulation and Terminology

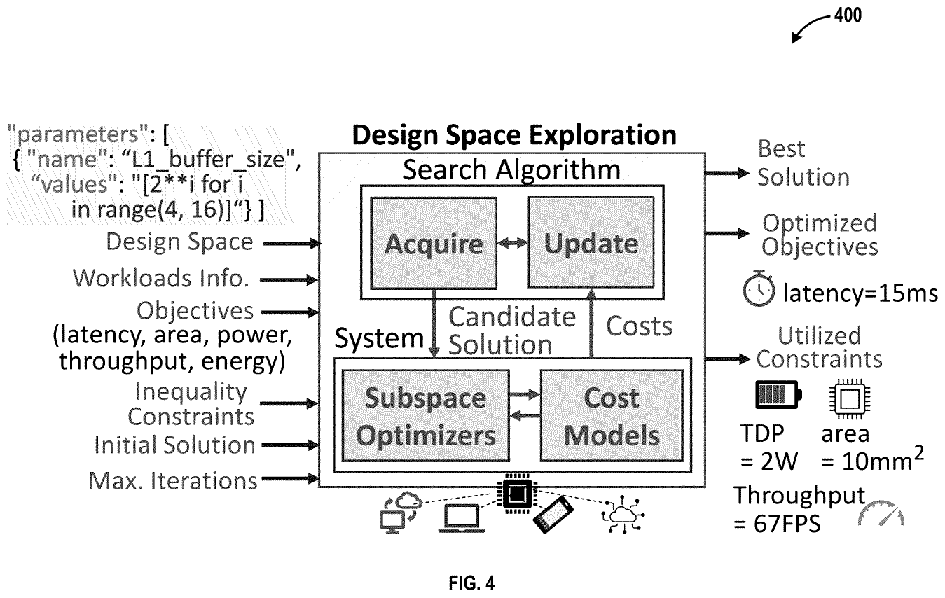

Exploration of accelerator designs is a constrained minimization problem, where the most efficient solution corresponds to minimized objective (e.g., latency), subjected to inequality constraints on some costs (e.g., area, power) and parameters p of accelerator design. FIG. 4 shows a diagram 400 illustrating the DSE problem formulation that led to the development of the Explainable-DSE framework outlined herein. During the optimization, every solution gets evaluated by cost models for objectives and inequality constraints. The Explainable-DSE framework needs to consider only feasible solutions and determine the most efficient solution by processing several iterations. It is a discrete optimization since the search space is usually confined to presumably effective solutions, e.g., power-of-two or categorical values of parameters. It is also derivative-free optimization. An example formulation for an optimization objective and set of constraints is provided below:

$$\begin{matrix}min & obj ( p ) , p = ( {p}_{1} , {p}_{2} , … , {p}_{n} ) ∈ {ℝ}^{n} \\ subject to & {cost}_{i} ( p ) \leq {constraint}_{i} ; for i = 1 , 2 , … , m\end{matrix}$$

### 3.2. DNN Accelerator Hardware/Software Codesigns DSE

Hardware/software codesigns can be explored by partitioning the search space and optimizing software space as a subspace in a loop. So, the DSE technique needs to find the best mapping of a task onto architecture and repeat the search with different architectural configurations. Partitioning enables exploration in reduced space compared to exploring parameters from multiple spaces altogether. DSE techniques for DNN accelerators explore hardware designs through non-feedback or black-box optimizations like evolutionary or ML-based. For mapping DNNs on a design (subspace optimization), they typically fix the way of execution or dataflow. Hence, for processing each functionality (nested loop such as a DNN layer), these techniques usually have just one mapping. Thus, they primarily optimize designs of accelerator architecture, i.e., parameters for buffers, processing elements (PEs), and NoCs.

### 3.3. Making DSE Explainable Through Bottleneck Analysis

FIG. 5B illustrates the same search problem of designing a DNN accelerator as in FIG. 5A, but by using bottleneck analysis in the DSE. Before acquiring a candidate, a device performing DSE analyzes the current design through the bottleneck model and pinpoints the bottleneck in achieved latency. Then, it uses mitigations suggested by the bottleneck model to make the next acquisitions. The bottleneck, in terms of latency optimization for a system such as a deep learning accelerator, can be attributed to execution factors such as time consumed by computations, communication via NoCs, and off-chip memory accesses with direct memory access (DMA) controller. For instance, after evaluating the initial point (number of PEs, shared memory size)=(64, 64 kB), the DSE can reason that the computation time of the design is 4.14× higher than the time taken by off/on-chip data communication. From the mitigation strategy, the DSE concludes and communicates to the designers that it would scale the total number of PEs next by at least 4.14×. Since this is the only mitigation suggested, the newly acquired and optimized design becomes (512, 64 kB). By repeating this process, the DSE informs that the previous bottleneck got mitigated and DMA-transfers is the new bottleneck. Using the bottleneck model, the DSE considers execution characteristics (like data accessed from off-chip memory and unexploited data reuse) and mitigation for the current design point, adjusting the size of shared on-chip memory or off-chip bandwidth. This iterative process continues. It enables the DSE to not just characterize, explain, and optimize DSE decisions and acquired designs, but also optimize objectives at almost every acquisition attempt and converge to efficient solutions quickly.

Just to note the power of explicit bottleneck mitigation strategies, if area constraint was unmet, DSE could intelligently let communication time increase but meet constraints first through reduced buffer/NoC sizes.

### 3.4. Challenges in Enabling DSE of DNN Accelerators Using Bottleneck Analysis

Need bottleneck models for DNN accelerator domain. DSE using bottleneck analysis requires bottleneck models. Unlike cost models used in black-box DSEs that provide a single value, bottleneck models can provide richer information about: 1) how design parameters contribute to different factors that finally lead to the overall cost; and 2) mitigation strategies when any of those factors gets identified as a bottleneck. Such bottleneck/root-cause analysis have been developed/applied for characterizing fixed designs and finding mitigation strategies, e.g., for industry pipelines and production systems, hardware or software for specific applications, FPGA-based HLS, overlapping microarchitectural events, and power outage. Likewise, optimizing DNN accelerator designs with bottleneck analysis also require developing bottleneck models.

Need an interface to decouple domain-specific bottleneck models from a domain-independent exploration mechanism and express them to DSE. Once bottleneck models are developed, there needs to be a DSE framework that can integrate such a domain-specific bottleneck model to drive the iterative search. However, since bottleneck models are usually domain-specific, search mechanisms provided by prior DSE techniques using bottleneck analysis are implemented too specifically for their domain. There needs to be an interface to decouple the domain-independent search mechanism from domain-specific bottleneck models so that designers can reuse and apply the same search mechanism for exploring designs in new domains like DNN acceleration.

Need acquisitions accounting for mitigations of multiple bottlenecks in workload executions. Prior DSE techniques using bottleneck analysis (in other domains) optimize only a single task at a time, i.e., consider a single cost value of executing a loop-kernel or whole task and iteratively mitigate arising bottleneck. However, when workloads involve different functions of diverse execution characteristics, e.g., a DNN with multiple layers or multiple DNNs, changing a design parameter impacts their contribution to the overall cost in distinct ways; considering just a total cost may not be useful. Mitigation strategies to address these layer-wise bottlenecks can lead to changing diverse parameters and a range of values possible for the same parameter. Therefore, when DSE framework makes its next acquisitions, it needs to ensure that multiple bottlenecks arising from executing different functions of target workloads are mitigated systematically and effectively.

### 3.5. Codesign Optimization

The optimization of hardware and software codesigns can be done either by exploring partitioned sub-spaces in a sequential manner or simultaneously. In a partitioned or a two-stage optimization, an outer loop iterates over different hardware configurations, and an inner loop optimizes the software space for each hardware configuration selected. On the other hand, the joint or simultaneous exploration involves finding a new configuration for both the hardware and software parameters at the same time in a trial. Although approaches using simultaneous search have been proposed, they are often infeasible to apply to a multi-workload exploration, target system with diverse and time-consuming cost evaluations, and huge collective search space. Therefore, partitioned sub-space exploration is commonly used for optimizing codesigns (§ 3.3). For demonstration of Explainable-DSE, DSE evaluations also follow two-stage optimization.

Firstly, approaches using simultaneous search typically optimize configurations for individual loop kernels such as a single DNN layer, as they optimize both the hardware and software parameters at every search attempt. This does not necessarily lead to a single accelerator design that is most efficient for the entire workload or a set of workloads, as layer-specific designs may not be optimal overall for the entire DNN or multiple DNNs.

Furthermore, optimizing both hardware and software parameters simultaneously can be very time-consuming. A target system often involves different cost functions or modules for different metrics that could consume different evaluation times. For example, evaluating area and power of each hardware configuration via Accelergy could take a few seconds, whereas the cost models of dMazeRunner or Timeloop could estimate latency/energy for hundreds—thousands of mappings in a second. For exploring codesigns for a DNN with L=50 unique layers, consider a black-box DSE that is budgeted H=2,500 trials for hardware configurations and M=10,000 trials for mapping each DNN layer on each hardware configuration. Simultaneous exploration of hardware and software configurations in H×M trials for each of the L layers requires the system to evaluate power/area costs for H×M×L times, which would take more than 0.7 million hours (79 years). In contrast, a two-stage partitioned exploration evaluates power/area costs only for H trials, and if the DSE samples infeasible mappings for a hardware configuration, they can be discarded promptly without further detailed evaluation. Experiments show that the black-box DSEs obtained codesigns in a few days to a few weeks with the partitioned exploration approach.

Finally, in addition to the design parameters such as the total PEs or buffer sizes, hardware configurations can have various parameters, such as bandwidth, reconfiguration of NoCs (time-multiplexed communication of data packets, bus widths), and those for architectural specialization/heterogeneity, which further increase the search space for both the hardware and software/mapping configurations. With the vast space for both the hardware and software/mapping configurations, the collective search space becomes huge, compounding the already challenging exploration of feasible and effective solutions for either of the hardware and software parameters. Additionally, in the DSE trials, simultaneously acquired hardware and software configurations may not be compatible with each other or may not mitigate execution inefficiencies corresponding to their counterpart.

### 4. EXPLAINABLE-DSE: A CONSTRAINED DSE FRAMEWORK USING BOTTLENECK ANALYSIS

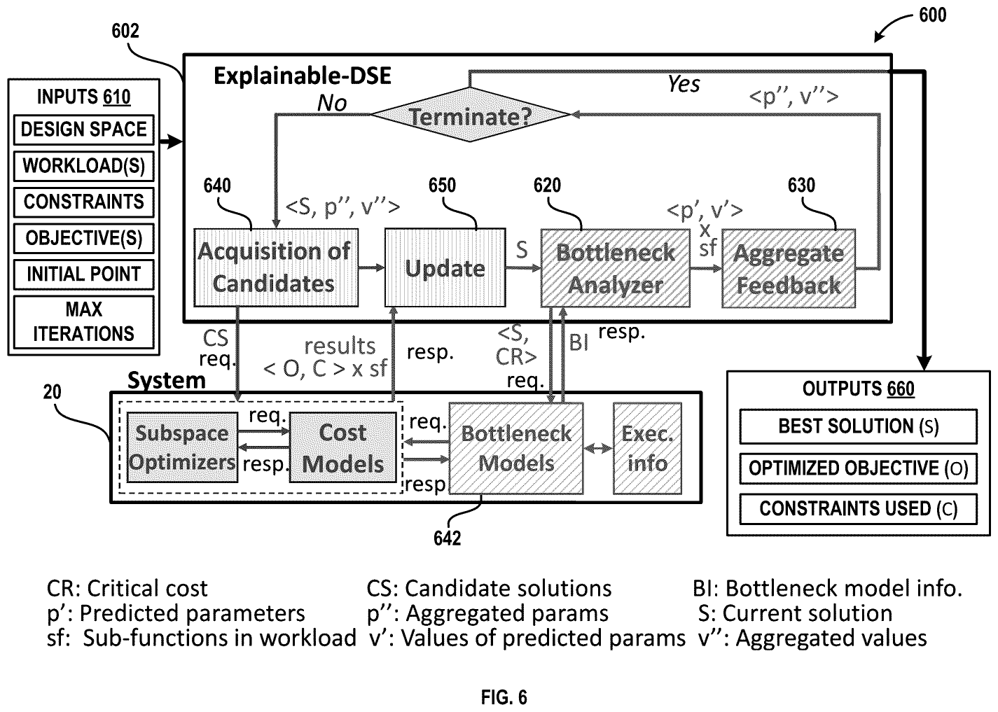

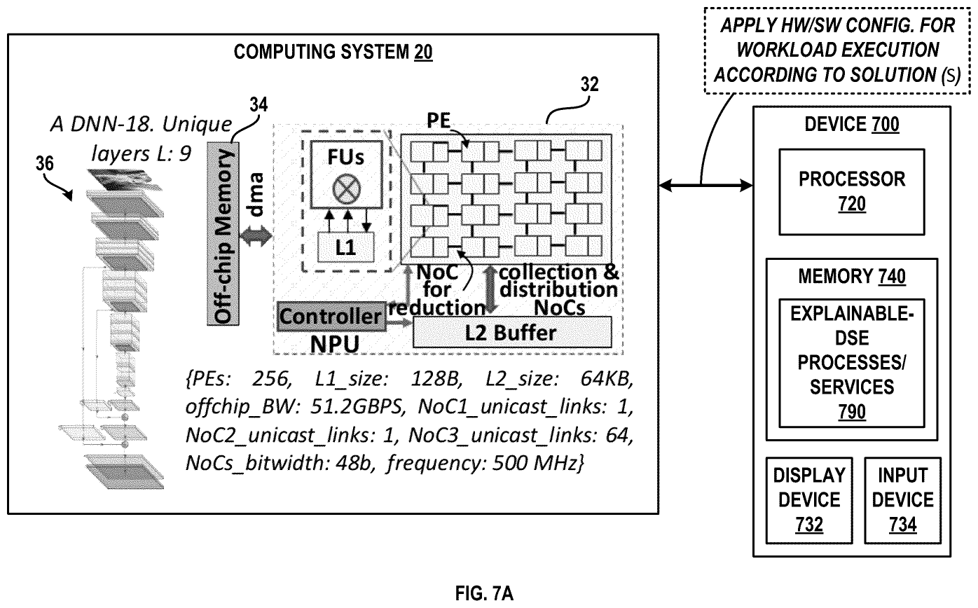

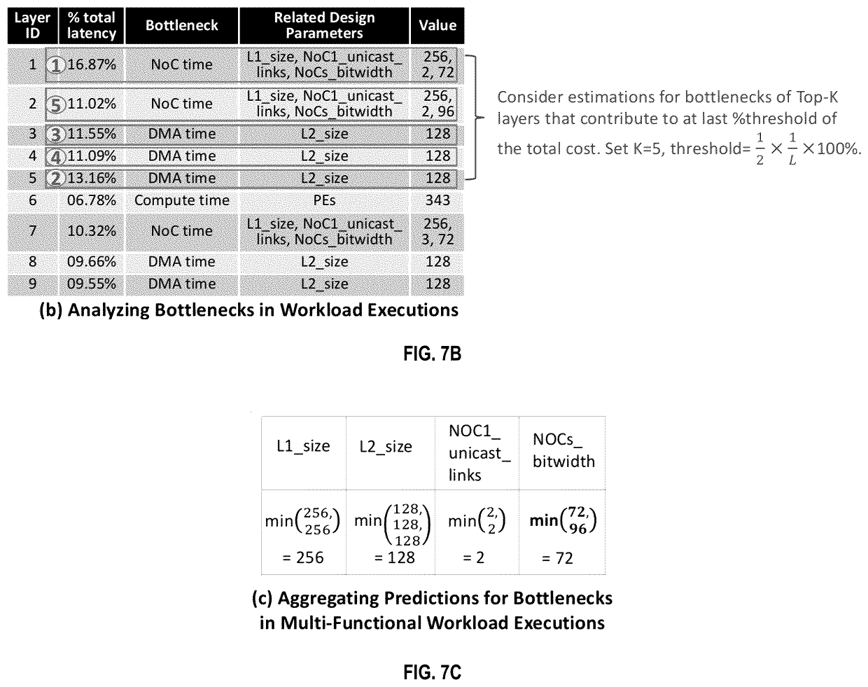

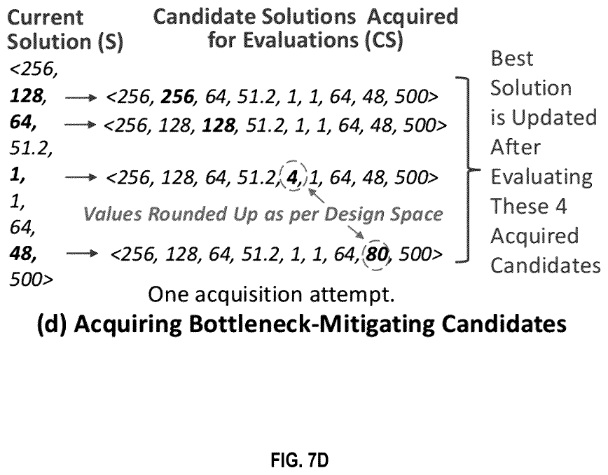

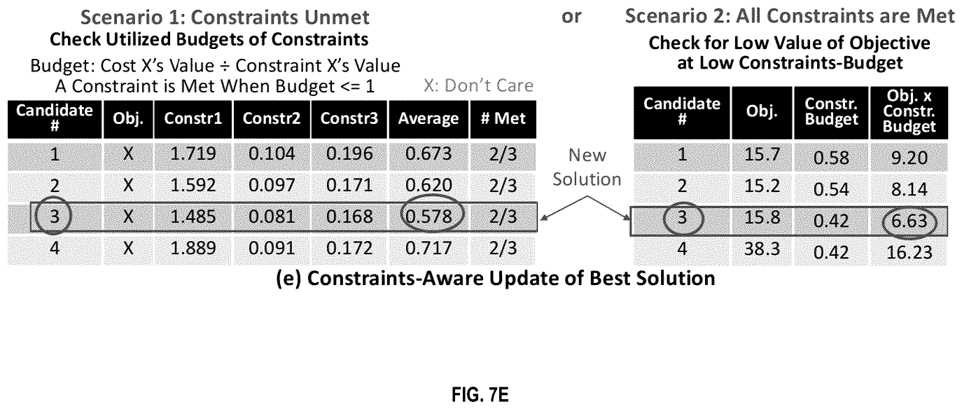

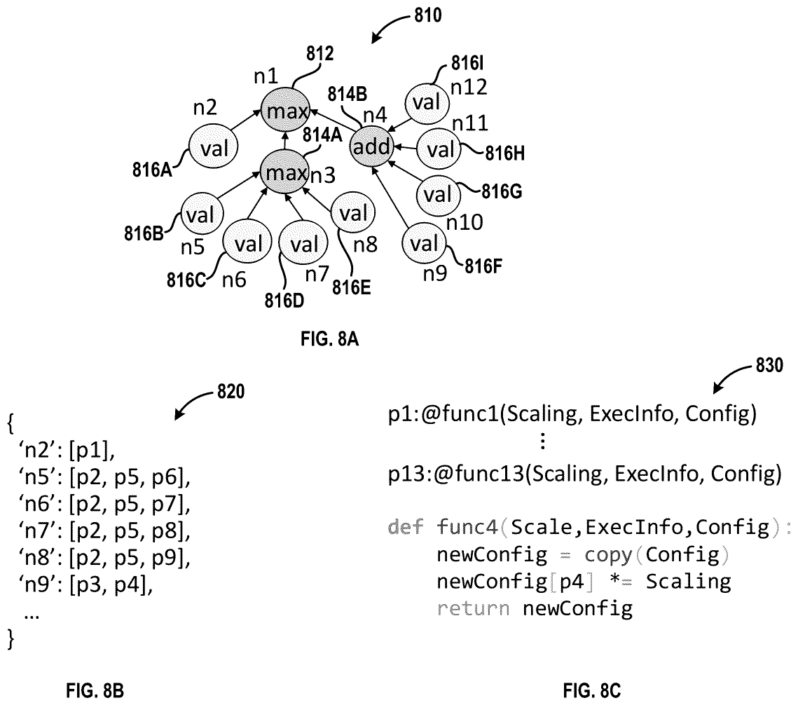

This section presents Explainable-DSE—a framework for an agile and explainable DSE using bottleneck analysis for optimizing deep learning accelerator designs. The Explainable-DSE framework can be implemented at a computing device in communication with a computing system to be optimized. First, with reference to FIG. 6, the present disclosure outlines an overall workflow of the Explainable-DSE framework. A walk-through example is shown in FIGS. 7A-7E. The present disclosure also describes how a bottleneck analyzer of the Explainable-DSE framework processes bottleneck models, i.e., determines factors incurring a high cost, parameters relevant to the bottleneck factors, and new values of parameters that can reduce the cost. Through FIGS. 8A-8C, the present disclosure also introduces an API through which architects can specify domain-specific bottleneck models, e.g., for accelerator execution costs. These bottleneck models can be used by the Explainable-DSE framework to construct bottleneck cost graphs for bottleneck analysis involving the execution of multiple functions within workload. The present disclosure discusses how the Explainable-DSE framework aggregates the obtained parameters and their new values, including considering bottlenecks of execution-critical functions. The present disclosure then describes how the Explainable-DSE framework considers inequality constraints when updating the obtained solutions, prioritizing the exploration of feasible regions. As an example, an in-depth bottleneck model is outlined to analyze and mitigate bottlenecks in exploring low-latency designs of DNN accelerators using the Explainable-DSE framework. Lastly, the present disclosure discusses how the Explainable-DSE framework can enable tightly coupled accelerator/mappings co-explorations.

### 4.1. Framework Workflow

FIG. 6 illustrates the Explainable-DSE framework, depicted as Explainable-DSE framework 600. In FIG. 6, the Explainable-DSE framework 600 can be implemented at a computing device (e.g., device 700 shown in FIG. 7A) that performs hardware-software (HW/SW) optimization of a computing system 20 for execution of one or more workloads at the computing system 20. The computing device implementing the Explainable-DSE framework 600 accesses inputs 610 including design space exploration information about the one or more workloads for execution by the computing system 20, as well as information about initial points and stop criterion (e.g., max iterations) for optimization of the computing system 20. The computing device implementing the Explainable-DSE framework 600 can iteratively and adaptively explore various hardware-software configurations, guided by bottleneck analysis, to produce an optimized hardware-software configuration for execution of the one or more workloads by the computing system 20. In the examples outlined in this section, a software space to be optimized jointly with hardware (e.g., through tightly-coupled hardware-software codesign) can refer to a mapping space or compiler optimization, e.g., a search space of the mapping workload functionality on a hardware configuration.

The Explainable-DSE framework 600 uses bottleneck analysis to explore solutions of a HW/SW configuration that reduce a critical cost, denoted as CR. Critical cost is usually an objective O that needs to be minimized and optionally an unmet inequality constraint value C. To reduce a critical cost, a bottleneck analyzer (“bottleneck analyzer 620”) of the Explainable-DSE framework 600 considers a current best solution (S) and analyzes a bottleneck model (e.g., through cost-related bottleneck information (BI) that can be observed from the computing system 20) to identify bottlenecks that would arise from implementation of the current best solution (S) at the computing system 20 when executing the workload. The bottleneck analyzer 620 can achieve this by constructing a bottleneck cost graph corresponding to a bottleneck model 622 for the function based on a current hardware-software configuration of the computing system 20 and resultant execution information about execution of the workload by the computing system 20. The bottleneck analyzer 620 of the Explainable-DSE framework 600 identifies bottleneck factors incurring higher cost value (e.g., represented as bottleneck-related nodes of the bottleneck cost graph that contributing to a bottleneck) and finds a scaling “s” by which the objective/constraint value needs to be reduced (“s” is internal to the bottleneck analyzer 620, and is not shown in FIG. 6). Then, the bottleneck analyzer 620 determines design parameters (“bottleneck-related parameters” (p′)) crucial for mitigating the bottleneck, along with their values (v′).

Workloads usually involve multiple functions or sub-functions (sf), e.g., different DNNs or layers in a DNN. So, the Explainable-DSE framework 600 applies bottleneck analysis to the costs of each function of the workload individually (at bottleneck analyzer 620) and then aggregates the corresponding feedback obtained (at “aggregate feedback” block 630). This aggregation leads to a set of predicted design parameters (p″) and their respective values (v″), where the set of predicted design parameters includes one or more bottleneck-related parameters that can be modified to mitigate the bottleneck. The set of predicted design parameters (p″) and their respective values (v″) correspond to a new set of candidate solutions (candidate solution set (CS)) for a subsequent acquisition attempt, where each candidate solution set includes candidate value(s) of one or more bottleneck-related parameters. The process iterates, as depicted in FIG. 6.

In this context, acquiring and evaluating candidates in a CS is referred to as one “acquisition attempt” by the Explainable-DSE framework 600, e.g., at “acquisition of candidates” block 640. It is analogous to z sequential DSE iterations if there are z candidates in a CS. The best solution, S, is updated once (from z candidates) at every acquisition attempt (e.g., at “update” block 650), which can be used to develop a new hardware-software configuration for execution of the one or more workloads by the computing system 20. When some inequality constraint is not met, the Explainable-DSE framework 600 considers the utilized budgets of constraints for acquired candidates in updating the best solution. This approach enables the Explainable-DSE framework 600 to prioritize reaching feasible subspaces. The new hardware-software configuration becomes the current hardware-software configuration for analysis at a subsequent iteration, and the process repeats until a solution set is found that produces an optimized hardware-software configuration of the computing system 20. In FIG. 6, the introduction of new modules of the Explainable-DSE framework 600 and corresponding information flow is illustrated through a diagonal stride pattern. The workings of these modules are described next, accompanied by a walk-through example (illustrated in FIGS. 7A-7E).

### 4.2. Framework Inputs and Outputs

Inputs: Inputs 610 to the Explainable-DSE framework 600 include design space exploration information about a design space, constraints, objective, workloads, initial point, and total iterations. Such information can include: a plurality of parameters to be optimized and corresponding possible values for each parameter of the plurality of parameters for execution of the one or more workloads; information about one or more optimization objectives associated with execution of the one or more workloads; information about one or more constraints associated with execution of the one or more workloads; and information about one or more tasks associated with execution of the one or more workloads. Outputs 660 of the Explainable-DSE framework 600 upon convergence or termination include an optimized solution set and its costs. The Explainable-DSE framework 600 can then produce, based on the optimized solution set, an optimized hardware-software configuration for execution of the workload by the computing system 20.

Design Space: The design space defines parameters of type integer, real, or categorical. Their possible values can be expressed as either a list or a mathematical expression.

Constraints and Objective: Users can define inequality constraints on multiple costs. While the implementation example shown herein optimizes a single objective, the Explainable-DSE framework 600 can be extended for multiple objectives through existing acquisition techniques.

Target System and Cost Models: The Explainable-DSE framework 600 can incorporate arbitrary cost models and subspace optimizations for populating costs. The Explainable-DSE framework 600 can also provide sub-costs at sub-function granularity, e.g., the latency of individual DNN layers. Such information can be obtained from the computing system 20 at an “execution info acquisition” block 644 that measures and reports cost values associated with execution of a workload to the Explainable-DSE framework 600. An API (§ 4.3) of the framework 602 enables definition and seamless integration of bottleneck models 642 (such as bottleneck model 210 discussed above with reference to FIG. 2) of the computing system 20.

To demonstrate DNN accelerator design explorations, existing cost models can be leveraged to evaluate all techniques. In one example implementation, Accelergy was used to obtain statistics such as total area, energy per data access (for 45 nm technology node), and maximum power. The maximum power is obtained from the maximum energy consumed by all design components in a single cycle. Accelergy provides technology-specific estimations via plugins for Aladdin and CACTI. Techniques such as application of dMazeRunner infrastructure can also be used to obtain statistics such as latency and energy consumed by mappings of DNN layers and for quick mapping optimizations for each architecture design.

### 4.3. Bottleneck Analyzer

Before each acquisition attempt, the Explainable-DSE framework 600 conducts bottleneck analysis (e.g., at bottleneck analysis block 620) on the previously obtained best solution (e.g., as a current hardware-software configuration of the computing system). It uses the bottleneck model, which helps pinpoint the execution bottlenecks and suggests solutions to mitigate them (as detailed in § 4.7), ultimately reducing costs.

As part of a bottleneck analysis methodology, the computing device implementing the Explainable-DSE framework 600 can first construct, for execution of a workload of the one or more workloads at the computing system 20, a bottleneck model expressive of an execution cost hierarchy of the workload in a graphical format for explicit analysis. For analysis of costs associated with a current hardware-software configuration (correlating with a current “solution set”) of the computing system 20, the computing device implementing the Explainable-DSE framework 600 can construct, for a function of a plurality of functions of one or more workloads for execution by the computing system 20, a bottleneck cost graph corresponding to the bottleneck model for the function based on the current hardware-software configuration. The bottleneck cost graph can represent a total execution cost of the function, one or more sub-costs that contribute to the total execution cost based on the bottleneck model, and values of one or more parameters of a solution set that contribute to the one or more sub-costs and/or the total execution cost of the function. Construction of the bottleneck cost graph can include steps of: executing a workload at the computing system 20, the computing system 20 being configured according to the current hardware-software configuration associated with the solution set; obtaining a set of execution characteristics of the workload according to the current hardware-software configuration associated with the solution set; determining values of the one or more sub-costs and the total execution cost of the workload based on the set of execution characteristics and based on values of parameters associated with the current hardware-software configuration; and populating the bottleneck cost graph based on an execution cost hierarchy of the workload represented by the bottleneck model, the bottleneck cost graph including the values of the one or more sub-costs and the total execution cost of the workload under the current hardware-software configuration of the computing system 20.

FIGS. 7A-7E demonstrate this exploration process by the Explainable-DSE framework (e.g., the Explainable-DSE framework 600) for an 18-layer DNN, where nine layers have unique tensor shapes for execution-critical operators (CONV (various types of convolutions) and GEMM (matrix-matrix or matrix-vector multiplications)). In particular, FIG. 7A shows an example embodiment of the computing system 20 to be optimized, including a DNN accelerator 32 in communication with an off-chip memory 34 for execution of a workload involving a DNN 36. The computing system 20 communicates with a computing device 700 that implements the Explainable-DSE framework 600 of FIG. 6. As shown, computing device 700 can include a processor 720 in communication with a memory 740, where the memory 740 includes instructions for implementation of the Explainable-DSE framework 600, e.g., as Explainable-DSE Processes/Services 790. The computing device 700 can include a display device 732 for displaying information about the optimization process such as the bottleneck cost graph, and can further include an input device 734 that allows a user to interact with the Explainable-DSE framework 600 in various ways, particularly with an API discussed herein. FIG. 7A also shows the architectural template and parameter values of the current best solution. FIG. 7B displays the bottleneck analyzer's ability to identify bottlenecks for each DNN layer and estimate which parameters should be updated with what specific values. This section further explains how the analyzer works and presents an API through which designers can specify their domain-specific bottleneck models for the DSE.

By evaluating the bottleneck cost graph based on the bottleneck model, the bottleneck analyzer 620 of the Explainable-DSE framework 600 determines: (a) bottleneck factors, (b) parameters that are most critical for reducing the costs of these bottleneck factors, and (c) values of these critical parameters. Designers can provide the information for bottleneck models through an API that can allow users to provide domain-specific information in the form of three data structures, as illustrated FIGS. 8A-8C. FIG. 8A shows a bottleneck graph 810 of a bottleneck model, which outlines a hierarchy of underlying factors contributing to the total cost. In the example, the bottleneck graph 810 includes a root node 812, branch nodes 814A and 814B, and leaf nodes 816A-816I. FIG. 8B includes a list of related parameters 820 for each factor, including hierarchy information about parameters that contribute to nodes of the bottleneck model. FIG. 8C shows handles 830 to subroutines that can be used to predict or otherwise determine “candidate values” of bottleneck-related parameters, e.g., which can be stored as instructions executable by the processor to determine a candidate value of a parameter associated with a node of the bottleneck model. When some information is unavailable, such as how to predict the value of a parameter, the Explainable-DSE framework 600 can select a new value by sampling from neighboring values.

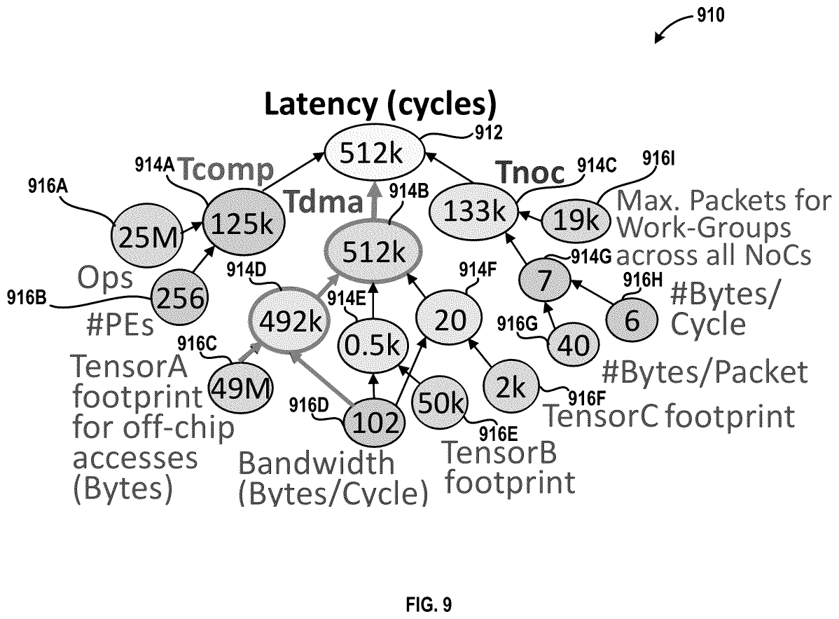

(a) Determining bottleneck factors from a bottleneck graph outlining execution factors: A bottleneck graph in the bottleneck model outlines how various factors contribute to a workload's execution cost, as depicted in FIG. 8A. The bottleneck graph can be represented as a tree whose branch nodes are mathematical functions like addition, multiplication, division, and maximum. Each node typically represents a cost factor, the value of which can be is calculated from its “children” by applying the corresponding mathematical function. FIG. 9 shows a simplified example of a bottleneck cost graph for a DNN layer execution that can be constructed based on a pre-defined bottleneck model for the for a DNN layer execution, where a root node 912 corresponds to a total execution cost (e.g., latency). The total execution cost depends on child nodes (e.g., branch nodes 914A-914G and leaf nodes 916A-916I) representing underlying cost factors, such as computational time or data communication time. For example, the total latency can be determined as the maximum value among the computational time, the total on-chip communication time, and the total DMA time for off-chip memory accesses. The total DMA time, in turn, can be additive and depends on the off-chip footprint of different tensors and the bandwidth. Similarly, the time for communicating data from on-chip buffers to PEs via NoCs is approximated with the total data packets communicated to different workgroups and NoC bus widths. Thus, leaf nodes typically represent values of primary components, such as design parameters and the accelerator's execution characteristics for a given workload/application. The execution characteristics include data allocated to buffers, on/off-chip communication of the data, unexploited reuse, etc. (§ 4.7).

For each acquisition attempt, the bottleneck analyzer 620 of the Explainable-DSE framework 600 considers the obtained (current) solution and populates a bottleneck cost graph (using the bottleneck model as a “template”) with the corresponding actual values, including values of design parameters and execution characteristics associated with a current hardware-software configuration of the computing system 20 and their resultant sub-costs and total execution costs. The bottleneck analyzer 620 can identify, for a function, one or more bottleneck-related nodes of the bottleneck cost graph associated with the solution set and the current hardware-software configuration, based on a relative contribution of the one or more sub-costs of the bottleneck cost graph to the total execution cost. Each bottleneck-related node of the one or more bottleneck-related nodes is associated with one or more sub-costs of the bottleneck cost graph. The bottleneck analyzer 620 can calculate, for a node of the bottleneck cost graph, the relative contribution of the node to a sub-cost of the one or more sub-costs or to the total execution cost, which can be considered as a ratio of its value to the total cost. In some examples, the bottleneck analyzer 620 traverses the bottleneck cost graph and computes the contribution of each factor based on the associated mathematical operation. For instance, at a “max” node, the bottleneck analyzer 620 traces back to a related sub-cost that provides the maximum value. At an “add” node, the bottleneck analyzer 620 counts contributions from related sub-costs proportionally. The bottleneck analyzer 620 identifies bottleneck-related nodes as nodes of the bottleneck cost graph that have the highest contribution as the primary bottleneck. This can involve comparing the relative contribution of the node to a contribution threshold, and identifying, based on comparison of the relative contribution to the contribution threshold, the node of the bottleneck cost graph as a bottleneck-related node of the one or more bottleneck-related nodes.

The bottleneck analyzer 620 can then calculate, for a bottleneck-related node of the bottleneck cost graph, the scaling factor “s”, which representing a targeted reduction ratio of the value of a sub-cost associated with the bottleneck-related node, e.g., the ratio by which the cost of the bottleneck factor should be reduced to alleviate the bottleneck.

In the example bottleneck cost graph of FIG. 9, DMA time dominates the total latency, whereas the computational and on-chip communication time contributes to only 24.4% and 25.9% of the total latency, respectively. The analyzer finds that the later latency factors can be balanced by scaling the DMA time down, e.g., by a factor of 100%÷25.9% or 3.85×. Through traversal, the analyzer identifies the memory footprint of tensor A as the primary bottleneck operand. The analyzer may also determine multiple bottlenecks (based on decreasing order of their contributions) so that an acquisition function of the Explainable-DSE framework 600 can generate an adequate number of candidates.

(b) Selecting Parameters Associated with the Bottleneck: To determine which parameters impact specific bottleneck factors, the bottleneck analyzer 620 of the Explainable-DSE framework 600 can traverse the bottleneck graph. Designers can also provide this information through a dictionary that maps the node names/numbers to relevant parameters (FIG. 8B). In the bottleneck graph 810 of FIG. 8A, nodes ‘n4’ and ‘n9’ correspond to DMA time and the off-chip footprint of Tensor A, respectively. They are associated with parameters ‘p3’ and ‘p4’ as indicated in FIG. 8B (e.g., ‘L2_size’ and ‘offchip_BW’ in FIG. 7A). Once the bottleneck factor and bottleneck-related parameters are identified, the Explainable-DSE framework 600 obtains new values from supporting subroutines.

(c) Obtaining Values of Critical Parameters with Mitigation Strategies: Designers can provide handles to domain-specific subroutines that describe mitigation strategies for different design parameters, as shown in FIG. 8C. Each subroutine calculates the new value of a bottleneck-related parameter based on the current value of the bottleneck-related parameter, the scaling factor s required for reducing the cost associated with the bottleneck-related parameter, and the execution characteristics of the current design configuration (§ 4.7). For example, the function ‘func4’ can scale the off-chip bandwidth to reduce DMA time, and functions ‘func5’ to ‘func8’ can scale the bus width or links of NoCs to lower the on-chip communication time. The Explainable-DSE framework 600 leverages these subroutines to predict new values of critical parameters and evaluates the corresponding design points to identify the best configuration.

### 4.4. Addressing Bottlenecks in Multi-Functional Execution

As FIG. 7B illustrates, the bottleneck analyzer 620 performs bottleneck analysis on each sub-function of workloads (DNN layer) one by one. Due to the diverse execution characteristics of these functionalities, the predictions obtained for each sub-function can be distinct, depending on the factors like available reuse and parallelism. Additionally, predictions for mitigating multiple bottleneck factors of various DNN layers may involve the same parameter. Hence, an aggregation step (“aggregate feedback” block 630 of FIG. 6) is required to determine the next set of parameters and their values (FIG. 7C). The Explainable-DSE framework 600 can employ two methods for aggregation:
(i) Aggregating different values of the same parameter: After analyzing solution S for bottlenecks of multiple sub-functions, there can be different predicted values of the same parameter. So, the final prediction can be obtained by either iterating over some of these values or applying a function (maximum, minimum, average) on the predicted values. Choosing the maximum value can lead to faster convergence, but it can favor a single sub-function and be overly aggressive for others. For instance, selecting a new value as 16× (from options like 4×, 8×, 16× the current number of PEs) can significantly reduce latency of a non-performance-critical DNN layer but not of other layers, while consuming higher area and power. Thus, exploration can quickly exhaust the budget for constraints without getting a chance to explore a considerable range of intermediate candidates that could minimize the overall cost. Instead, for this example, the logical minimum of the estimated values is taken as the final prediction (shown in FIG. 7C).
(ii) Aggregating parameters from only bottleneck sub-functions: Not all sub-functions or cost factors require improvement. The Explainable-DSE framework 600 allows focusing on the bottleneck ones, i.e., contributing the most to the total cost. This capability is achieved through two user-tunable parameters: K and threshold. The Explainable-DSE framework 600 considers predictions from up to top-K sub-functions whose fractional contributions to the total cost exceed a certain threshold. In target DNNs, the number of layers with unique tensor shapes (l) can range from a few to several tens. So, for one example implementation, K was set to five and the threshold to 0.5*(1/l)*100%, considering predictions from layers that consume higher portions of the cost. As FIG. 7B shows, the bottleneck analyzer 620 considers mitigating bottlenecks from the top-5 layers that contribute at least 5.5% to the total latency.

### 4.5. Bottlenecks-Aware Acquisitions of Candidates

After aggregating parameter values for mitigating bottlenecks, the Explainable-DSE framework 600 populates candidate solutions CS to be acquired next (“acquisition of candidates” block 640 of FIG. 6). For simplicity, the acquisition function samples a candidate for each new value of a parameter. As FIG. 7D shows, all but one parameter of the candidate has the same value as the current solution. This mechanism naturally facilitates an iterative search that adaptively tunes among bottleneck parameters. Acquisition by the framework Explainable-DSE framework 600 avoids falling into a greedy local search by the following means: i) it limits exploration parameters to a few (critical for addressing the bottleneck); and ii) it can predict values of larger step-size (non-neighbors) based on bottleneck mitigation analysis (whereas local search explores all p immediate neighboring values of all p parameters in the selected solution). Acquisitions by addressing multiple, dynamic bottlenecks (different parameters to be optimized at each DSE iteration) and exploring larger step sizes usually help avoid over-optimization of a design within the local neighborhood (converging to local optimal). Due to the modular design of the framework, users also may specify other acquisition/update functions that act upon bottlenecks-mitigating parameters. When acquiring a candidate, if a predicted value is not present in the defined design search space (e.g., non-power-of-2), the Explainable-DSE framework 600 rounds it up to the closest value.

### 4.6. Constraints-Budget-Aware Update of Solution

When exploring a vast space under tight constraints, initially acquired solutions usually fail to meet all constraints (e.g., low-area, high-latency region, or vice versa). To effectively explore the space, the Explainable-DSE framework 600 accounts for the constraints budget when selecting the best solution (e.g., at “update” block 650 of FIG. 6), which, in turn, impacts the acquisitions of new candidates. In determining a new solution from explored candidates, the Explainable-DSE framework 600 first checks whether the solutions meet all constraints and by what margin. If any candidate does not meet all constraints, it selects a candidate as the best solution that uses the least constraints budget. The constraints budget is calculated as the average of the utilized constraint values that are normalized to constraint thresholds. Such accounting is illustrated in FIG. 7E—scenario 1. Further, for monomodal cost models, when a candidate (corresponding to the new value of some parameter) violates more constraints than the obtained solution, the Explainable-DSE framework 600 can disable further exploration of the parameter's range. Thus, by prioritizing the feasibility of solutions, the Explainable-DSE framework 600 limits acquiring solutions that optimize the objective at the expense of violating constraints. When multiple candidates satisfy all constraints (as in scenario 2 of FIG. 7E), the Explainable-DSE framework 600 selects the one (as the new solution) that achieves the lowest objective value with a lower constraints budget, i.e., the smallest value for objective×constraints budget. Such a strategy can help avoid greedy optimization that chases marginal objective reduction and rather seeks more promising solutions.

As such, a bottleneck mitigation methodology employed by the Explainable-DSE framework 600 can include updating a value of a bottleneck-related parameter of the solution set to include candidate value based on one or more constraints associated with joint optimization of a plurality of functions of the one or more workloads. This can further include: determining a candidate value of a bottleneck-related parameter associated with the bottleneck-related node based on the scaling factor; constructing one or more candidate solution sets, each candidate solution set including candidate values of the one or more bottleneck-related parameters associated with the bottleneck-related node that are predicted to reduce the value of the sub-cost associated with the bottleneck-related node based on the scaling factor; and selecting, from the one or more candidate solution sets, updated values of the one or more bottleneck-related parameters in view of the one or more constraints associated with execution of the one or more workloads.

### 4.7. Bottleneck Mitigations for DNN Accelerators

In this disclosure, latency of executing a DNN is used as an example cost for a bottleneck model of DNN accelerator/mapping codesigns. This disclosure outlines what information about latency can be analyzed and how to predict parameters that mitigate various bottlenecks.

Information embedded in bottleneck model: The bottleneck model incorporates execution characteristics of an optimized mapping of a DNN layer onto an architecture design. They include:
T_comp T_comm, T_dma: Total time consumed by computations on PEs, communicating data via NoCs, and accessing data from off-chip memory via DMA, respectively.
Accel_freq: Frequency of the accelerator (MHz).
data_offchip: Data (bytes) accessed from off-chip, per operand.
data_noc: Data (bytes) communicated via NoC, per operand.
NoC_groups_needed: Maximum number of concurrent links that can be provided for communicating unique data to different PE-groups; one variable per operand.
NoC_bytes_per_group: Size of the data that can be broadcast to PEs within every PE-group; one variable per operand.

Using above information, a bottleneck graph can be created as illustrated in FIG. 9. Typically, this information is available from experts-defined cost models. If not, it may be obtained through similar analysis, hardware counters, or ML models.

Dictionary of Affected Parameters: A dictionary of affected parameters can include different factors contributing to the latency as keys and a list of relevant parameters as values. For example, the computation time is affected by the number of PEs and functional units in PEs. The time consumed by NoC communication is affected by the concurrent unicast links in NoCs, bit-widths of NoCs, and size of the local buffer or RF. The buffer size impacts the exploited reuse and the size of the data to be communicated. DMA time is affected by the bandwidth for off-chip memory accesses and the size of the shared memory.

Determining Values of Accelerator Design Parameters: Analyzing the bottleneck graph of a cost provides s, which is the scaling to be achieved by reducing a bottleneck factor's cost. X_current and X_new indicates the current and predicted value of a parameter X, respectively. X is a parameter impacting the bottleneck factor (obtained from dictionary). The disclosure next describes the calculation for various design parameters.

PEs: The number of PEs required can be calculated directly from the needed speedup. PEs_new=s*PEs_current.

Off-chip BW: Bandwidth (BW) for off-chip and on-chip communication is obtained from the number of data elements communicated per operand and targeted speedup. E.g.,

scaled_T_dma=T_dma÷s;

footprint=sum(data_offchip),

bytes_per_cycle=footprint÷scaled_T_dma

offchip_BW_new=bytes_per_cycle*Accelerator_freq

NoC Links and Bit-width: For DNN accelerators, separate NoCs communicate different operands, each with multiple concurrent links for various PE groups. For every NoC, the maximum number of PE-groups with simultaneous access and the total bytes broadcast to each group are obtained from the cost model. If communication time is a bottleneck, the operand causing it (‘op’) is available from the bottleneck analysis of the graph. Then, for the corresponding NoC, its width (bits) is scaled to make the broadcast faster based on the needed speedup. The new value is clamped to avoid exceeding the maximum width feasible for a one-shot broadcast.

max _width_feasible=exec_info[noc_bytes_per_group][op]*8

width_scaled=noc_width_current*s

noc_width_new=min(width_scaled,max_width_feasible)

Similarly, total unicast links needed by the NoC for op are calculated from required concurrent accesses by PE groups.

max_links_feasible=exec_info[noc_groups_needed][op]

lnk_scaled=noc_unicast_links_current[op]*s

unicast_links_new[op]=min(lnk_scaled,max_links_feasible)

Whenever the number of PE-groups requiring different data elements exceeds available unicast links (by V×), data is uni-cast with time-sharing (V times) over configurable NoC (as in Eyeriss) to facilitate mapping. Parameter virtual_unicast_links indicates time-sharing over a unicast link, which can be set as number of time-sharing instances (V).

Sizing RFs and Memory: The total NoC communication time can be reduced by increasing the bottleneck operand (op)'s reuse in the RF (local buffer) of PEs. Increasing the reuse by R requires (R×) larger chunks of non-bottleneck operands, which need to be stored in RF and communicated via other NoCs. Using the information about non-exploited (available) reuse of the bottleneck operand and the required speedup, the new RF size can be calculated as:

target_scaling=min(max_reuse_avadable_RF[op], S)

RF_size_new=Σₒₚ_{ᵢ}┌exec_info[data_RF][opᵢ]*

target_scaling÷reuse_available_RF[opᵢ]┐

The calculation is similar for global scratchpad memory, except for targeted scaling. In off-chip data communication, multiple operands are communicated one by one via DMA (unlike simultaneously by NoCs per operand). So, the targeted speedup depends on the bottleneck operand's (with remaining reuse) contribution (f) to the total off-chip footprint. The speedup achievable through reuse (A) can be approximated with Amdahl's law as: A=(s*f)÷(1−s+(s*f)) target_scaling=min(max_reuse_available_SPM[op], A) SPM_size_new=Σₒₚ_{ᵢ}┌exec_info[data_SPM][opᵢ]*target_scaling÷reuse_available_SPM[opᵢ]┐

For validation, the Explainable-DSE workflow and bottleneck analysis for DNN accelerators was implemented in Python. It allows easy interfacing with DNN accelerator cost models. Since the implementation of the bottleneck analysis module and multi-bottleneck DSE are external to the cost model, they could be extended to interface with other cost models like MAESTRO that make execution characteristics available (e.g., bandwidth, Ops, data packets to be communicated).

### 4.8. Tightly Coupled Hardware/Software Co-Explorations

Efficient codesign requires optimizing both hardware configurations and mappings in a coordinated manner. However, when using back-box DSEs, these configurations are typically explored in a loosely coupled manner, as in the acquired values usually do not address inefficiencies in the achieved execution with their counterpart. For example, the acquired values of off-chip/NoC bandwidth may be inefficient for the selected loop tile configuration in the same/previous trials, resulting in significantly higher communication time and total latency.

To address these inefficiencies, the Explainable-DSE framework integrates mapping space optimizations for DNN executions, and it explores HW/SW codesign in a tightly coupled manner through bottleneck-based exploration. It considers software optimization as a subspace, which allows tailoring hardware configurations for obtained software configurations and optimizing software configurations to utilize hardware resources effectively. For a hardware configuration, when the Explainable-DSE framework optimizes mappings through explorations or even a fixed schema, it mostly leads to efficient executions that can adapt to the tensor shapes and workload characteristics (reuse, batching, parallelism, etc.). Then, the Explainable-DSE framework finds bottlenecks in the optimized executions obtained. In the next acquisition attempt, the Explainable-DSE framework acquires new hardware candidates such that they address bottlenecks in the executions optimized previously by software configurations. Once a new hardware design is updated as the solution, software configurations are optimized again in tandem. Consequently, this approach leads to an efficient code-sign for diverse tensor shapes and workload characteristics.

To enable efficient exploration of hardware/mapping code-sign within practical budgets, the Explainable-DSE framework needs to explore quality mappings quickly. The Explainable-DSE framework builds on previous research on mappers for DNN accelerators that eliminate infeasible and ineffective mappings by pruning loop tilings and orderings. For fast mapping optimizations, one implementation of the framework integrated and extended dMazeRunner , which can find near-optimal solutions within seconds. Mappers like dMazeRunner, Interstellar, or ZigZag consider comprehensive space, optimally prune loop orderings, and prune tilings based on utilization of architectural resources (PEs, buffers, non-contiguous memory accesses). However, one challenge with their fixed utilization thresholds for pruning is that they may lead to a search space that either includes too few mappings (e.g., tens) for some DNN layers or too many (many thousands) for others. To address this challenge, these search hyperparameters of dMazeRunner were automatically adjusted to formulate the mapping search space that includes up to the top-N mappings based on utilization thresholds. N is the size of pruned mapping space formulated by iteratively adjusted thresholds, which must be within a user-specified range, such as [10, 10000]. These mapping trials are then evaluated linearly, as in dMazeRunner or Timeloop. This approach helps achieve quality mappings by pruning ineffectual methods like in dMazeRunner/Interstellar, while also ensuring reasonably large space of high-quality mappings as per user-specified exploration budget.

### 5. EXPERIMENTAL METHODOLOGY

Benchmarks: Eleven DNNs are evaluated for Computer Vision (CV) and Natural Language Processing (NLP) tasks. CV models include ResNet18, MobileNetV2, and Efficient-NetB0 (light) and VGG16, ResNet50, and Vision Transformer (heavy) for classifying ImageNet images. The light and heavy labels differentiate models based on inference latency and total computations. For object detection, recent models FasterRCNN-MobileNetV3 and YOLOv5 (heavy) were evaluated. NLP models include Transformer for English-German sentence translation and BERT-base-uncased for Q&A on SQuAD dataset. Facebook wav2vec 2.0. for ASR was also evaluated. Their DNN layers are 18, 53, 82, 16, 54, 86, 79, 60, 163, 85, and 109 respectively. Models were obtained from PyTorch and Hugging Face frameworks.

Design Space: Table 1 lists the design space of a DNN accelerator for inference at the edge. As in existing accelerators, four dedicated NoCs were considered for a total of four read/write operands. The number of links for concurrent or time-shared unicasting is per NoC. To minimize the space for related techniques, the number of unicast links were expressed as a fraction of total PEs. Execution constraints were selected based on the requirements for ML benchmarks and designs of industrial edge accelerators for ML inference. The objective was set as minimizing the latency of the single-stream execution.

TABLE 1
Design Space for Edge DNN Accelerators.
Data: int16; Freq. 500 MHz; Constraints: Throughput >=40/10
FPS (vision light/heavy), 120/530/176k samples/second
(NLP: Transformer/BERT/wav2vec2); Area <75 mm²;
Max. power <4 W. Objective: Minimize latency.

| Parameter | Values | Options |
|---|---|---|
| PEs | 64, 128, . . . , 4096 | 7 |
| L1 buffer (B) | 8, 16, . . . , 1024 | 8 |
| L2 buffer (KB) | 64, 128, . . . , 4096 | 7 |
| Offchip | 1024, 2048, 4096, 6400, 8192, | 10 |
| bandwidth (MBPS) | 12800, 19200, 25600, 38400, 51200 | |
| NOC datawidth | 16*i; i: [1, 16] | 16 |
| Physical unicast (×4) | PEs*i/64; i: [1, 64] | 64⁴ |
| Virtual unicast (×4) | 2³ⁱ; i: [0, 3] | 4⁴ |

DSE Techniques: Explainable-DSE was evaluated against previous accelerator DSE frameworks using constrained optimizations—Hypermapper 2.0 (based on Bayesian optimization) and Confuciux—reinforcement learning (RL). Confuciux limits the total parameters to two, works with a single constraint, and requires the same number of values for all parameters. So, its implementation was generalized for evaluations. The approach was evaluated against non-feedback or black-box approaches like Grid search, Random search, Simulated annealing (Scipy), Genetic algorithm (Scikit-Opt), and Bayesian optimization. All techniques were evaluated on a Dell precision 5820 tower workstation. Like previous DNN accelerator DSEs, validated cost models were used. The system for evaluating the candidates with cost models was same for all techniques.

Mapping Optimizations and Codesign Explorations: Prior works mostly used a fixed dataflow, such that exploration time is primarily spent on optimizing hardware configurations, while getting efficient mappings with fixed strategy. So, the mapping technique was first fixed as an optimized output stationary dataflow (SOC-MOP) for all approaches. Then, the codesign with Explainable-DSE is demonstrated by a tightly coupled optimization of both the hardware and mapping configurations. Obtained codesigns are also compared with those obtained by black-box approaches. Black-box codesign DSE explores hardware configurations with two techniques that were found effective: random search and HyperMapper 2.0 (based on Bayesian optimization). For mapping each DNN layer on every hardware configuration, black-box DSE uses Timeloop-like random search for 10,000 mapping trials, as it was found effective in quickly obtaining high-quality mappings.

Exploration Budget: 2500 iterations were considered for statically finding the best solutions. Dynamic DSE capabilities are also analyzed by explorations in 100 iterations.

### 6. RESULTS AND ANALYSIS

### 6.1. Explainable-DSE Obtained Codesigns of 6× Low Latency in 47× Less Iterations and 36× Less Time

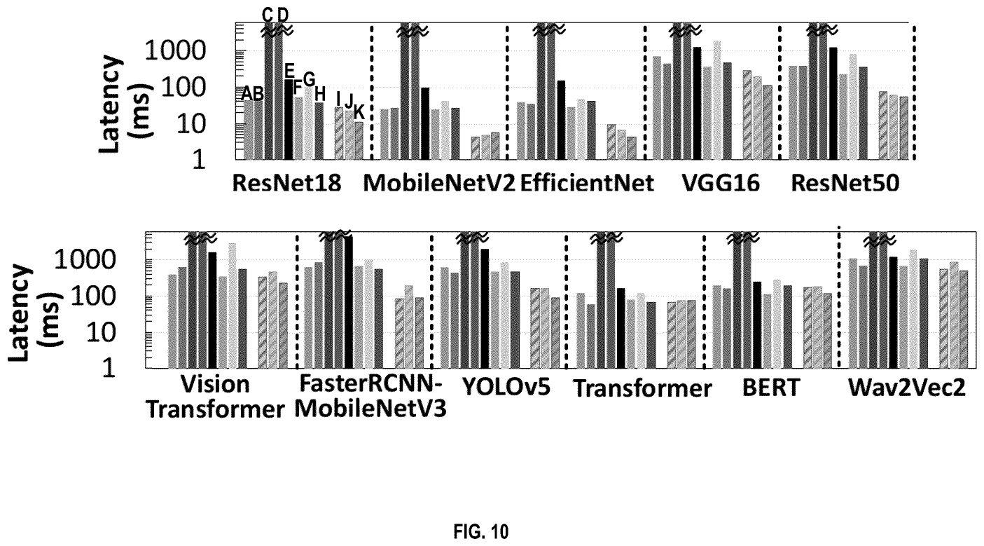

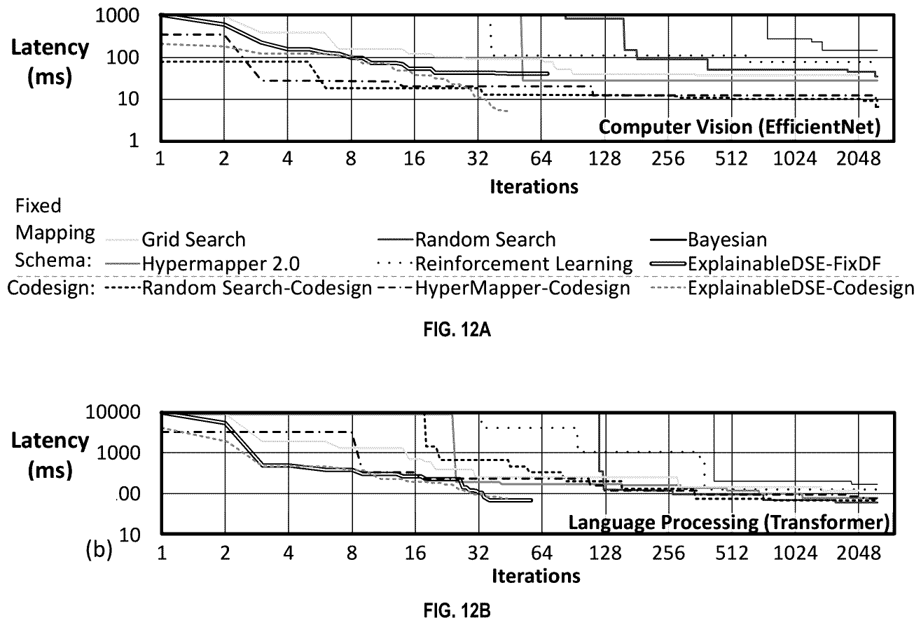

FIG. 10 illustrates the latency obtained by different techniques for static exploration. By exploring among quality solutions, Explainable-DSE obtained 6× more efficient solutions, on average, as compared to previous approaches, and up to 9.6× over random search and 49.3× over Bayesian optimization. Even when dataflow (schema for optimized mappings) was fixed for all techniques, it obtained 1.77× lower latency on average and up to 7.89×. By applying bottleneck analysis on workload executions at every acquisition attempt, Explainable-DSE could determine parameters critical for improving efficiency. Thus, it can effectively navigate high-reward subspaces among the vast space. FIGS. 12A and 12B illustrate this with latency reduction obtained over iterations by taking examples of two models, EfficientNet for CV and Transformer for NLP. With objective reduction at almost every attempt, the Explainable-DSE converges to quality solutions early on (some tens of iterations), and usually of better efficiency; e.g., obtained solutions have 6.6×-35.1× lower latency for EfficientNet, as compared to DSEs with fixed dataflow and 2.1×-9.7× as compared to black-box co-optimization. Overall, at every attempt, it reduced the values of objective for feasible acquisitions by geomean 1.30× and 1.32× for fixed and co-explored mappings (as shown in Table 2). Acquisitions of non-explainable techniques, being bottlenecks-unaware, do not increasingly focus on high-reward sub-spaces. In fact, in some evaluations for Bayesian, random, constrained RL, overall growth was negative. For instance, many feasible candidates were acquired by these techniques without understanding bottlenecks, which corresponded to lower efficiencies than previously obtained best solutions.

TABLE 2
At every acquisition attempt, Explainable-DSE reduces objective
by 30% vs. ~1.4% by non-explainable techniques.

| | | | | | | Vision |
|---|---|---|---|---|---|---|
| DSE Technique | ResNet18 | MobileNetv2 | EfficientNet | VGG16 | ResNet50 | Transformer |
| Grid Search-FixDF | 1.71% | 1.03% | 1.07% | 1.21% | 1.25% | 1.41% |
| Random Search-FixDF | 0.52% | −0.87% | 7.34% | −2.26% | 4.69% | −4.29% |
| Simulated Annealing-FixDF | N/A | N/A | N/A | N/A | N/A | N/A |
| Genetic Algorithm-FixDF | N/A | N/A | N/A | N/A | N/A | N/A |
| Bayesian Optimization-FixDF | 11.26% | 26.57% | 19.57% | 19.22% | −1.09% | −4.89% |
| HyperMapper 2.0 | 5.32% | 1.21% | 0.44% | 2.67% | 4.94% | 4.86% |
| Reinforcement Learning-FixDF | −0.75% | −4.13% | 5.18% | −2.51% | −2.97% | −10.47% |
| Random Search-Codesign | −0.07% | −0.29% | 0.14% | 0.44% | 0.33% | 0.57% |
| HyperMapper 2.0-Codesign | 0.56% | 0.46% | 0.59% | 0.64% | 0.68% | 0.68% |
| ExplainableDSE-FixDF | 53.54% | 21.92% | 20.48% | 52.42% | 15.32% | 31.74% |
| ExplainableDSE-Codesign | 30.50% | 23.45% | 32.10% | 32.03% | 18.77% | 46.29% |

| | FasterRCNN- | | | | | |
|---|---|---|---|---|---|---|
| DSE Technique | MobileNetv3 | YOLOv5 | Transformer | BERT | Wav2Vec2 | Average |
| Grid Search-FixDF | 0.71% | 0.55% | 0.98% | 1.04% | 1.07% | 1.09% |
| Random Search-FixDF | −1.41% | −0.90% | 0.01% | 0.97% | −1.45% | 0.21% |
| Simulated Annealing-FixDF | N/A | N/A | N/A | N/A | N/A | N/A |
| Genetic Algorithm-FixDF | N/A | N/A | N/A | N/A | N/A | N/A |
| Bayesian Optimization-FixDF | −10.01% | −12.28% | 10.15% | −0.27% | 11.33% | 6.32% |
| HyperMapper 2.0 | −0.20% | 0.87% | 1.40% | 3.35% | 1.18% | 2.37% |
| Reinforcement Learning-FixDF | 0.67% | 1.66% | 4.62% | 0.50% | −0.50% | −0.79% |
| Random Search-Codesign | 0.23% | 0.91% | 0.48% | −0.24% | 0.02% | 0.23% |
| HyperMapper 2.0-Codesign | 0.72% | 0.76% | 0.43% | 0.52% | 0.73% | 0.62% |
| ExplainableDSE-FixDF | 23.73% | 21.54% | 30.96% | 40.66% | 21.44% | 30.34% |
| ExplainableDSE-Codesign | 27.03% | 18.78% | 26.19% | 47.30% | 46.70% | 31.74% |

N/A is indicated when a technique could not find a single feasible hardware-software codesign solution.

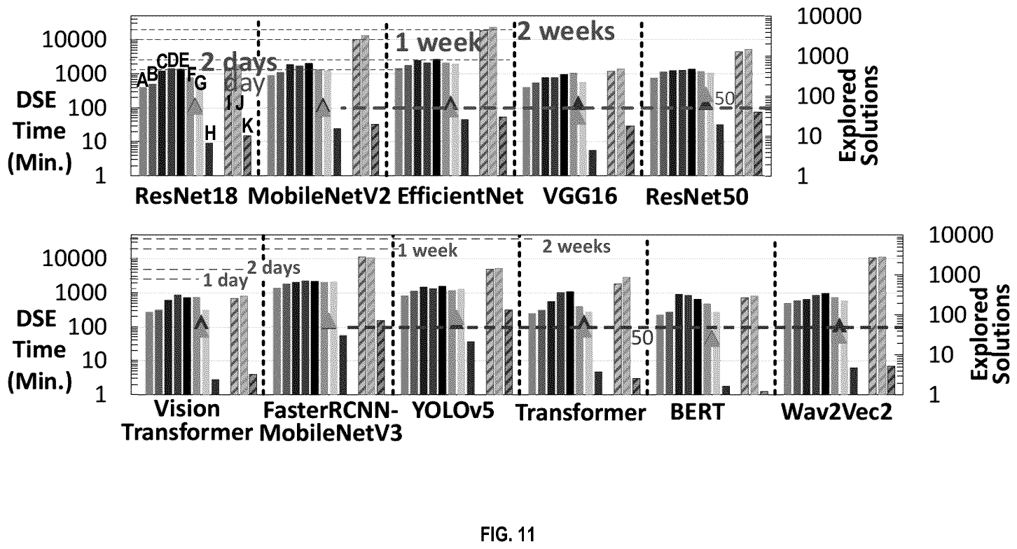

FIG. 11 shows the total time (bars) taken by DSE techniques. Through constraints accommodation and systematically mitigating bottlenecks in multi-functional workload executions, explorations quickly converged or terminated while achieving even more efficient solutions. For example, Explainable-DSE with fixed and optimized mappings explored about only 59 and 54 designs, respectively (shown by triangles; ˜2500 for other techniques). This translated in search time reduction of 53× and 103× on average over black-box explorations, when using fixed dataflow for all techniques and hardware/mapping co-optimization, respectively. Maximum reduction in the search time was up to 501× and 1675×, respectively. Using modest information on mitigating bottlenecks, the Explainable-DSE framework consumed only 21 and 64 minutes, on average. In fact, they achieved the most efficient solutions for BERT under just two minutes.

### 6.2. Including Software Design Space in the Exploration Enables 4.24× Better Solutions

With the availability of exploration budget (by a drastic reduction in the search time), hardware/software codesigns can truly be enabled by optimizing both of them in a tightly coupled manner. codesigns obtained with Explainable-DSE reduced objective by 4.24× on average, as compared to using a single optimized mapping per DNN operator. The higher efficiency emanates from achieving better mappings tailored for processing various DNN layers (different functionality and tensor shapes of DNN operators) on the selected hardware configuration. They leverage higher spatial parallelism and more effectively hide data communication latency behind computations, as compared to a pre-set dataflow. Further, mapping optimizations reduce the objective considerably, without necessarily increasing hardware resources. Thus, by having a more constraints-budget on hand, DSE reduced the objective further (also evident in FIG. 12A).

For exploring comprehensively defined vast space of architectural configurations with non-explainable DSEs, presetting dataflow can lead to many infeasible solutions (§ 6.3). Note that infeasible solutions are not just hardware configurations with exceeding constraints like area or power. The designs can also be infeasible when generated hardware configuration is incompatible with the used software, i.e., dataflow for mapping. For instance, in configurations generated by non-explainable DSEs, the total number of links for time-shared unicast was often lower than that needed by spatial parallelism in the dataflow used for mapping. That's exactly why a codesign or joint exploration with the software is important.

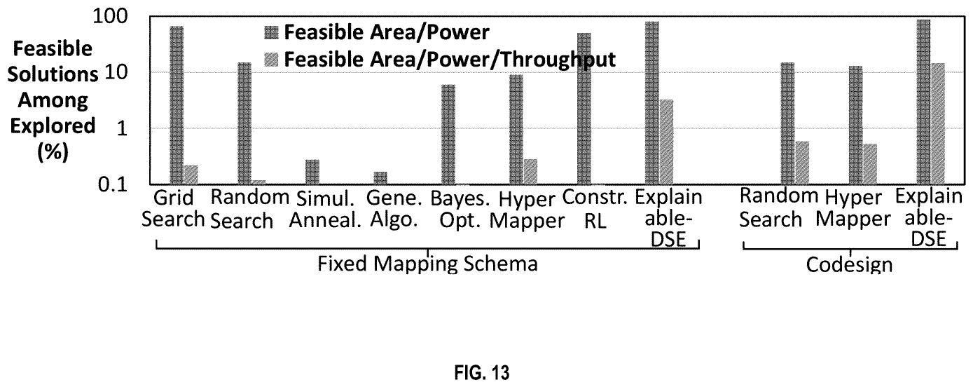

Black-box co-optimizations incorporated mapping explorations and reduced latency of obtained solutions further by 2.33× for HyperMapper 2.0 and 2.63× for random search, as compared to their DSEs using a fixed schema for optimized mappings. This is primarily because of the availability of more constraints-budget at hand, as discussed before. The co-optimizations also alleviated aforementioned challenge of mapping-hardware incompatibility. As FIG. 13 shows, the black-box co-optimizations find more feasible designs, when hardware design configurations are explored for the same number of trials. However, even after 2500 trials for exploring hardware configurations and 10,000 trials for exploring mappings of each DNN layer on every hardware configuration, the latency of codesigns obtained by black-box approaches are still 1.6× higher than the codesigns obtained by Explainable-DSE, while consuming 103× more search time (Taking 7-16 days for four workloads). Key reasons for such effective explorations by Explainable-DSE include generating fewer yet objective-reducing trials and tightly coupled codesigns. As Explainable-DSE leverages the domain knowledge, its generated designs target addressing execution inefficiencies, converging in 47× less iterations. In black-box co-optimizations, the DSE is loosely coupled, as in generated hardware configuration is not necessarily tailored to work best with the optimized mappings (from the previous/same trial for the hardware DSE). In contrast, tightly coupled codesign in Explainable-DSE explores hardware configurations that alleviate inefficiencies in the workload executions optimized previously by mappings; once new hardware configuration is generated, mapping exploration strives to utilize hardware resources effectively and lowers costs further. And, this repeats. Thus, optimizations for both hardware and software configurations strive to reduce inefficiencies in the execution optimized by their counterpart.

Although optimizing the mappings for every hardware design requires additional search time, the overall increase for exploring codesigns with Explainable-DSE was only 3× on average (from 21 minutes to 64). In fact, for all but heavy object detection models, the DSE time increased from 16 minutes to only 26 minutes. One reason is that the mappings can be quickly evaluated with analytical performance models (e.g., a minute each for several hundred to a few thousand mappings) and concurrent execution with multiple threads (subjected to execution on 4 cores at maximum in evaluations). Moreover, applying bottleneck analysis on efficient mappings helped obtain efficient designs faster (1.1× lower iterations for hardware designs on average, and up to 1.9×). Whenever the DSE for codesign evaluated a similar number of architecture designs as Explainable-DSE with fixed dataflow, it went on to explore even more efficient solutions (e.g., 2.33× lower latency for Vision Transformer).

### 6.3. By Considering the Utilization of Constraints, DSE Mostly Focuses on Feasible Solutions

Non-explainable black-box optimization approaches, e.g., with Genetic Algorithm or Bayesian Optimization, did not know which configurations could likely lead to feasible subspaces. Therefore, even after exploration over days, they almost did not obtain a single feasible solution. When considering only area and power constraints, feasibility of explored solutions was higher for mostly all techniques (FIG. 13), e.g., 15% for the random search and 50% for constraints-aware reinforcement learning. However, when considering throughput requirement for inference, the feasibility of the explored solutions was barely ˜0.1%-0.3%. By exploring the mappings, the black-box codesign optimizations addressed the challenge of mappings being incompatible for the obtained hardware configurations. Thus, they improved feasibility by 2×-5×, but the overall feasibility was still ˜0.6%. Such low feasibility for DSE in humongous space is presumably caused due to DSEs not accommodating constraints during exploration and bottlenecks-unaware acquisition trials. Contrarily, Explainable-DSE prioritized to meet the constraints for its acquisitions and update of the best solutions, which helped avoid infeasible subspaces. Plus, addressing bottlenecks in executions helped acquiring high-performance solutions. Hence, 87% and 15% of solutions explored by Explainable-DSE code-signs were feasible when considering area and power constraints and all the three constraints, respectively. For DNNs like BERT and MobileNetV2, 89%-98% of the explored solutions met area and power constraints. Once Explainable-DSE achieved a solution that met all constraints, it always ensured to optimize further with a feasible solution.

### 6.4. Enabling Efficient Dynamic Exploration in Vast Space

Table 3 shows latency of solutions achieved in 100 iterations by different techniques. Under a short exploration budget, non-explainable techniques did not find a feasible solution (shaded values). Even after ignoring throughput requirements, most techniques could not find feasible solutions. Contrarily, by exploring spaces where candidates utilize low budget of constraints, Explainable-DSE quickly landed feasible solutions. Black-box approaches explored feasible codesigns, but they did not meet throughput requirements. On the other hand, by addressing the bottlenecks in multi-functional executions, Explainable-DSE achieved solutions of one to two orders of magnitude lower latency over other techniques.

TABLE 3
Latency minimized by DSE Techniques in 100 iterations.
Explainable-DSE evaluated ~54 solutions. Designs obtained by Non-Explainable
DSEs were low-throughput (shaded values) and incompatible with dataflow (dashes).

| | | | | | | Vision |
|---|---|---|---|---|---|---|
| DSE Technique | ResNet18 | MobileNetv2 | EfficientNet | VGG16 | ResNet50 | Transformer |
| Grid Search-FixDF | 278 | 73.4 | 92.0 | 3650 | 747 | 1973 |
| Random Search-FixDF | —* | 197 | 694 | 41912 | 626 | 1376 |
| Simulated Annealing-FixDF | —* | —* | —* | —* | —* | —* |
| Genetic Algorithm-FixDF | —* | —* | —* | — | —* | — |
| Bayesian Optimization-FixDF | — | — | — | — | — | — |
| HyperMapper 2.0-FixDF | 53.3 | 46.5 | 135 | 1339 | 493 | 1308 |
| Reinforcement Learning-FixDF | — | — | 360 | — | — | — |
| Random Search-Codesign | 69.6 | 12.7 | 9.5 | 870 | 209 | 857 |
| HyperMapper 2.0-Codesign | 63.1 | 5.1 | 10.3 | 1233 | 87.3 | 1084 |
| ExplainableDSE-Codesign | 11.2 | 5.7 | 4.3 | 109 | 54.9 | 233 |

| | FasterRCNN- | | | | |
|---|---|---|---|---|---|
| DSE Technique | MobileNetv3 | YOLOv5 | Transformer | BERT | Wav2Vec2 |
| Grid Search-FixDF | 1625 | 1477 | 251 | 780 | 1933 |
| Random Search-FixDF | 3152 | 7754 | 157 | 1044 | 2357 |
| Simulated Annealing-FixDF | —* | —* | —* | —* | —* |
| Genetic Algorithm-FixDF | — | —* | —* | —* | —* |
| Bayesian Optimization-FixDF | — | — | — | — | — |
| HyperMapper 2.0-FixDF | 13582 | 1142 | 171 | 663 | 912 |
| Reinforcement Learning-FixDF | 21150 | 18082 | 143 | 1428 | 1428 |
| Random Search-Codesign | 224 | 218 | 244 | 240 | 1427 |
| HyperMapper 2.0-Codesign | 830 | 348 | 133 | 637 | 1945 |
| ExplainableDSE-Codesign | 89.2 | 92.1 | 76.2 | 121 | 494 |

More importantly, * denotes none of the obtained candidates met even area/power constraints.

### 7. ADDITIONAL INFORMATION

Execution Cost Models of DNN Accelerators: The cost models of SECDA and TVM/VTA support end-to-end simulation and synthesis, while faster analytical models are more commonly used to optimize mappings and accelerator design configurations. Their examples include MAESTRO, Accelergy, SCALE-Sim, and those of Timeloop, dMazeRunner, and Interstellar infrastructures. Most of these models estimate both latency/throughput and energy. In addition to computational cycles, MAESTRO, dMazeRunner, and Timeloop account for on-chip and off-chip communication latency. For Explainable-DSE, the cost model of dMazeRunner infrastructure was used, which also considers the performance overheads of non-contiguous memory accesses and allows explicit specification of NoC bandwidths and flexibly specifying mappings through loop nest configurations.

Mappers for DNN Accelerators: Mappers typically target the space of all valid loop tilings and orderings. For tensor shapes of a layer, there can be many factors of loop iteration counts, and just populating the space of valid mappings could be time-consuming (microseconds—several seconds). Timeloop, a commonly used mapper, explores mappings through random sampling, while GAMMA uses a genetic algorithm. However, GAMMA limits the number of loops that can be executed spatially and does not prune invalid tilings before exploration, requiring several-fold more trials for convergence. Without eliminating ineffectual loop tilings and orderings beforehand, black-box explorations typically require thousands of trials, generating many invalid mappings, and take hours to map a single DNN layer once. Mind Mappings reduces the search time by training a surrogate model that estimates costs faster than analytical models. CoSA uses a prime factorization-based approach to construct the tiling space for a mixed-integer programming solver. But, many tilings corresponding to combinations of prime factors remain unexplored, potentially resulting in sub-optimal solutions. Additionally, most mappers do not support depthwise-convolutions, invoking convolutions channel-by-channel. So, they miss opportunities for exploiting parallelism across multiple channels and reducing miss penalties for accessing contiguous data of consecutive channels from the off-chip memory.

Interstellar prunes ineffectual tilings by constraining the search to pre-set resource utilization thresholds. dMazeRunner goes further and prunes loop orderings for unique/maximum reuse of operands and proposes heuristics that reduce the space to highly efficient mappings, which can be explored in second(s). Hence, the dMazeRunner infrastructure is utilized in the codesign and extended to construct the space of up to top-N mappings, where N is the maximum mapping trials allowed. ZigZag and follow-up mappers build upon such pruning strategies. ZigZag allows uneven blockings of loops for processing different tensors, which may partially improve efficiency. However, ZigZag's search time for a DNN layer is nearly hours. While works such as optimize DNN mappings on one or more hardware accelerators, they require exploring hardware parameters exhaustively or with black-box optimizations.

Hardware/Software Codesign Explorations of DNN Accelerators: Previous DNN-accelerator DSEs used black-box optimizations. They incur excessive trials and ineffectual solutions, as they lack reasoning about the higher costs of obtained candidates and the potential efficiency of candidates to be acquired next (§ 2). Further, some DSEs used a fixed dataflow in explorations. It obviates increasing search time further but may not lead to the most efficient solutions compared to codesigns.

Recent approaches HASCO and DiGamma optimize both hardware and mapping configurations in a black-box manner, encountering the same challenges of ineffectual and excessive trials due to non-explainability (§ 2). Second, with a loosely coupled codesign exploration (§ 4.8), they acquire HW/SW configurations that may not be effective or suitable for the counterpart. Furthermore, they target a limited hardware design space comprising only buffers and PEs. Finally, they typically do not explore a single accelerator design that addresses inefficiencies in executing DNNs with many layers.

DSE Using Bottleneck Analysis: While some DSEs use bottleneck analysis, these DSEs are constraints-unaware and optimize only a single loop-kernel. Plus, they explored only neighboring values of parameters (instead of scaling them to mitigate bottleneck in one shot). It leads to search time comparable to black-box DSEs. AutoDSE and SECDA proposed bottleneck models specific to FPGA-based HLS and their search optimizes a single loop-kernel/task of a single workload at a time. While bottleneck models are presented herein for the DNN accelerator domain; the DSE framework generalizes prior bottleneck-based DSEs to the case of multiple loop-nests and multiple workloads through aggregation of bottleneck mitigations. Further, via proposed API and data structures, the framework decouples bottleneck models from search algorithms, allowing designers to express their bottleneck models.

### 8. CONCLUSIONS

Agile and efficient exploration in the vast design space, e.g., for hardware/software codesigns of DNN accelerators, require techniques that not just should consider objectives and constraints but are also explainable. They need to reason about obtained costs for acquired solutions and how to improve underlying execution inefficiencies. Non-explainable DSE with black-box optimizations (evolutionary, ML-based) lack such capability; obtaining efficient solutions even after thousands of trials or days can be challenging. To overcome such challenges, Explainable-DSE is outlined herein, which analyzes execution through bottleneck models and determines the bottleneck factors behind obtained costs and acquire solutions based on relevant mitigation strategies. The demonstration of optimizing codesigns of DNN accelerators presented herein showed how Explainable-DSE could effectively explore feasible and efficient candidates (6× low-latency solutions). By obtaining most efficient solutions in short exploration budgets (47× fewer iterations or minutes/hours vs. days/weeks), it opens up cost-effective and dynamic exploration opportunities.

### 8.1 Capabilities and Distinguished Features

This section highlights the capabilities of Explainable-DSE for agile and explainable design space explorations.

Efficient designs. Explainable-DSE finds better solutions since it investigates costs and bottlenecks that incur higher costs; by exploring candidates that can mitigate inefficiencies in obtained designs, DSE provides efficient designs.

Quick DSE. The DSE can reduce objective values at almost every acquisition attempt; it searches mostly in feasible/effectual solution spaces. Thus, DSE achieves efficient solutions quickly, which is beneficial for the early design phase and for dynamic DSEs, e.g., deployments of accelerator overlays at run time. Additionally, it can help when acquisition budgets are limited, e.g., due to evaluation of a solution consuming minutes to hours. Further, when designers optimize designs offline with hybrid optimization methodologies comprising multiple optimizations, quickly found efficient solutions can serve as high-quality initial points.

Explainability in the DSE and design process. This work shows the need for explainability in the design process, e.g., in exploring the vast design space of deep learning accelerators, and how DSE driven by bottleneck models can achieve explainability. Exploration based on bottleneck analysis can help explain why designs perform well/poorly and which regions are well-explored/unexplored in vast space and why.

Generalized bottleneck-driven DSE for multiple micro-benchmarks and workloads. In acquiring new candidates, the DSE accounts for various bottlenecks in executing multiple loop nests (e.g., DNN layers) of diverse execution characteristics. Thus, the DSE can provide a single solution that is most effective overall, in contrast to previous DSEs that provide loop-kernel-specific solutions.

Specification for expressing domain-specific bottleneck models to the DSE. This work proposes an API for expressing domain-specific bottleneck models so that the designers can integrate them to bottleneck-driven DSE frameworks and reuse the DSE.

Comprehensive design space specification. In the DSE, appropriate values of a parameter is selected through bottleneck models. Thus, the DSE can alleviate the need for fine-tuning the design space; users can comprehensively define/explore vast space, e.g., more parameters and large ranges of values (arbitrary instead of power-of-two).

Bottleneck analysis for hardware/software codesign of deep learning accelerators. By taking the latency of accelerators as an example, this work shows how to construct bottleneck models for designing deep learning accelerators and bottleneck analysis for improving the accelerator designs based on their execution characteristics.

### 9. METHODS

A method for defining bottleneck models outlined herein includes: displaying, at a display device in communication with the processor, an interface that includes information about a bottleneck model of one or more workloads; accessing a bottleneck model input from a user or a design automation tool defining the bottleneck model; and storing, at a memory in communication with the processor, information about the bottleneck model based on the bottleneck model input. To define the bottleneck model, the method can include constructing, for execution of a workload of the one or more workloads at the computing system, the bottleneck model expressive of an execution cost hierarchy of the workload in a graphical format for explicit analysis. The bottleneck model can include a root node correlating with the total execution cost associated with the workload, a branch node represented by a mathematical operator and indicating a sub-cost that contributes to the total execution cost, and a leaf node representing a value of a design parameter or an execution characteristic that contributes to the sub-cost or the total execution cost. In some examples, the method can further include storing hierarchy information about one or more nodes of the bottleneck model based on the bottleneck model input; and storing instructions executable by a processor to determine a candidate value of a parameter associated with a node of the bottleneck model based on the bottleneck model input.

A method outlined herein can include accessing, at the processor, design space exploration information about the one or more workloads for execution by the computing system, the design space exploration information including: information about a design space defining a plurality of parameters to be optimized and corresponding possible values for each parameter of the plurality of parameters for execution of the one or more workloads; information about one or more optimization objectives associated with execution of the one or more workloads; information about one or more constraints associated with execution of the one or more workloads; and information about one or more tasks associated with execution of the one or more workloads.

The method can include the steps of: (i) constructing, at a processor and for a function of a plurality of functions of one or more workloads for execution by a computing system, a bottleneck cost graph corresponding to a bottleneck model for the function based on a current hardware-software configuration of the computing system, the bottleneck cost graph representing a total execution cost of the function, one or more sub-costs that contribute to the total execution cost based on the bottleneck model, and values of one or more parameters of a solution set that contribute to the one or more sub-costs and/or the total execution cost of the function; (ii) identifying, for the function, one or more bottleneck-related nodes of the bottleneck cost graph associated with the solution set and the current hardware-software configuration, based on a relative contribution of the one or more sub-costs of the bottleneck cost graph to the total execution cost, each bottleneck-related node of the one or more bottleneck-related nodes being associated with one or more sub-costs of the bottleneck cost graph; (iii) aggregating, for the plurality of functions of the one or more workloads, one or more candidate values of one or more bottleneck-related parameters of the one or more parameters of the bottleneck cost graph that contribute to sub-costs associated with the one or more bottleneck-related nodes of the bottleneck cost graph, each candidate value of the one or more candidate values being associated with a bottleneck-related parameter of the one or more bottleneck-related parameters; (iv) updating a value of the bottleneck-related parameter of the solution set to include a candidate value of the one or more candidate values based on one or more constraints associated with joint optimization of the plurality of functions of the one or more workloads; and (v) producing, based on the solution set, an optimized hardware-software configuration for execution of the one or more workloads by the computing system. The method can further include iteratively repeating steps (i)-(iv) until a stop criterion is reached.

The method can further include steps associated with step (i) outlined above, including: executing a workload of the one or more workloads at the computing system in communication with a memory hierarchy via networks on chip, the computing system being configured according to the current hardware-software configuration associated with the solution set; obtaining a set of execution characteristics of the workload according to the current hardware-software configuration associated with the solution set; determining values of the one or more sub-costs and the total execution cost of the workload based on the set of execution characteristics and based on values of parameters associated with the current hardware-software configuration; and populating the bottleneck cost graph based on an execution cost hierarchy of the workload represented by the bottleneck model, the bottleneck cost graph including the values of the one or more sub-costs and the total execution cost of the workload under the current hardware-software configuration of the computing system.

The method can further include steps associated with a bottleneck analysis methodology and step (ii) outlined above, including: calculating, for a node of the bottleneck cost graph, the relative contribution of the node to a sub-cost of the one or more sub-costs or to the total execution cost; comparing the relative contribution of the node to a contribution threshold; and identifying, based on comparison of the relative contribution to the contribution threshold, the node of the bottleneck cost graph as a bottleneck-related node of the one or more bottleneck-related nodes,

The method can further include steps associated with a bottleneck mitigation methodology and steps (iii) and (iv) outlined above, including: determining, for a bottleneck-related node of the bottleneck cost graph, a scaling factor representing a targeted reduction ratio of the value of a sub-cost associated with the bottleneck-related node; determining a candidate value of a bottleneck-related parameter associated with the bottleneck-related node based on the scaling factor; constructing one or more candidate solution sets, each candidate solution set including candidate values of the one or more bottleneck-related parameters associated with the bottleneck-related node that are predicted to reduce the value of the sub-cost associated with the bottleneck-related node based on the scaling factor; and selecting, from the one or more candidate solution sets, updated values of the one or more bottleneck-related parameters in view of the one or more constraints associated with execution of the one or more workloads.

In some examples, the one or more workloads can include one or more deep neural network models. The computing system to be optimized can include including a deep learning accelerator for execution of the plurality of functions of one or more workloads. In these examples, the candidate value of the one or more candidate values can include one or more of: a predicted value of a number of processing elements of the computing system predicted to reduce a computation time according to the scaling factor; a required value of off-chip bandwidth predicted to reduce a time taken by off-chip memory accesses according to the scaling factor; a set of bit-width requirements predicted to reduce a time taken by communication via networks on chip according to the scaling factor, including a predicted networks-on-chip bit width for an operand of a plurality of operands corresponding to the function; a set of unicast, multicast, or other interconnect link requirements predicted to reduce a time taken by communication via networks on chip of the computing system according to the scaling factor, including a predicted quantity of links for each network on chip corresponding to an operand of a plurality of operands of the function; a local buffer size requirement of a local buffer private to a processing element of the computing system predicted to reduce a time taken by communication via networks on chip according to the scaling factor, considering possible data reuse, including a total predicted local buffer size for a plurality of operands of the function; and/or a global scratchpad memory size requirement of one or more global scratchpad memories of the computing system predicted to reduce a time taken by off-chip memory accesses according to the scaling factor, considering possible data reuse, including a total predicted global scratchpad memory size for a plurality of operands of the function.

In a further aspect, a method for adaptive and tightly coupled hardware and software codesign of a workload executable by a computing system includes: executing, at a computing system in communication with a memory hierarchy via networks on chip, a workload including a plurality of operations for execution using a deep neural network model under a current hardware-software configuration of the computing system; iteratively applying, at a processor in communication with the computing system, an optimization methodology for optimization of execution of the workload at the computing system; and producing an optimized hardware-software configuration for execution of the workload by the computing system. The step of iteratively applying the optimization methodology can further include: applying a bottleneck analysis methodology for finding bottlenecks in execution of plurality of operations of the deep neural network model; and applying a bottleneck mitigation methodology that modifies the current hardware-software configuration of the computing system to satisfy a set of constraints for design and execution of the workload, including a total power consumption, chip area, throughput, energy consumption, and latency.

In yet a further aspect, a method for developing bottleneck models for analysis of execution of a workload at a deep learning accelerator includes: executing, at a deep learning accelerator in communication with a memory hierarchy via networks on chip and based on a current hardware-software configuration of the deep learning accelerator, a workload including a plurality of operations of a deep neural network model; applying, at a processor in communication with the deep learning accelerator, a bottleneck analysis methodology to the deep learning accelerator based on execution of the workload; and producing, based on the scaling factor, an optimized hardware-software configuration for execution of the workload by the deep learning accelerator. The step of applying a bottleneck analysis methodology can include: obtaining, at the processor, a set of execution characteristics based on application of one or more analytical models of costs of executing a deep neural network model on a deep learning accelerator under the current hardware-software configuration; constructing, at the processor and based on a set of accelerator design parameters and execution characteristics obtained, a bottleneck cost graph representing execution costs of the workload at the deep learning accelerator under the current hardware-software configuration; and determining, at the processor and based on the bottleneck cost graph, a scaling factor of a value of a bottleneck-related parameter of the current hardware-software configuration predicted to improve execution efficiency of the workload by the deep learning accelerator.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### Computer-Implemented System

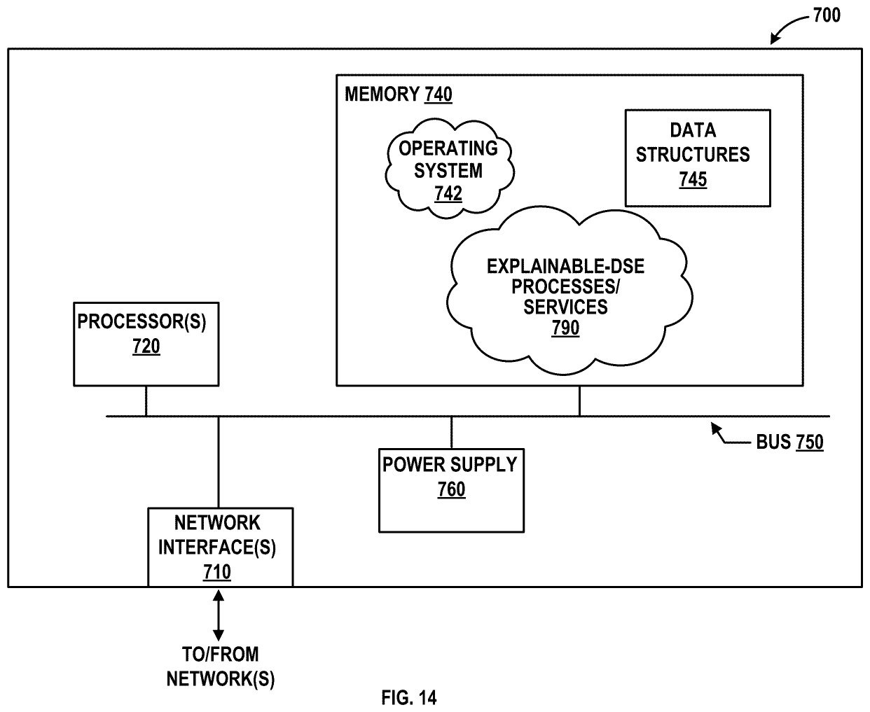

FIG. 14 is a schematic block diagram of the computing device 700 shown in FIG. 7A that may be used with one or more embodiments described herein.

Device 700 comprises one or more network interfaces 710 (e.g., wired, wireless, PLC, etc.), at least one processor 720, and a memory 740 interconnected by a system bus 750, as well as a power supply 760 (e.g., battery, plug-in, etc.).

Network interface(s) 710 include the mechanical, electrical, and signaling circuitry for communicating data over the communication links coupled to a communication network. Network interfaces 710 are configured to transmit and/or receive data using a variety of different communication protocols. As illustrated, the box representing network interfaces 710 is shown for simplicity, and it is appreciated that such interfaces may represent different types of network connections such as wireless and wired (physical) connections. Network interfaces 710 are shown separately from power supply 760, however it is appreciated that the interfaces that support PLC protocols may communicate through power supply 760 and/or may be an integral component coupled to power supply 760.

Memory 740 includes a plurality of storage locations that are addressable by processor 720 and network interfaces 710 for storing software programs and data structures associated with the embodiments described herein. In some embodiments, device 700 may have limited memory or no memory (e.g., no memory for storage other than for programs/processes operating on the device and associated caches). Memory 740 can include instructions executable by the processor 720 that, when executed by the processor 520, cause the processor 720 to implement aspects of the Explainable-DSE framework 600 and associated methods outlined herein.

Processor 720 comprises hardware elements or logic adapted to execute the software programs (e.g., instructions) and manipulate data structures 745. An operating system 742, portions of which are typically resident in memory 740 and executed by the processor, functionally organizes device 700 by, inter alia, invoking operations in support of software processes and/or services executing on the device. These software processes and/or services may include Explainable-DSE processes/services 790, which can include aspects of the methods and/or implementations of various modules described herein. Note that while Explainable-DSE processes/services 790 is illustrated in centralized memory 740, alternative embodiments provide for the process to be operated within the network interfaces 710, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the Explainable-DSE processes/services 790 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method, comprising:
(i) constructing, at a processor and for a function of a plurality of functions of one or more workloads for execution by a computing system, a bottleneck cost graph corresponding to a bottleneck model for the function based on a current hardware-software configuration of the computing system, the bottleneck cost graph representing a total execution cost of the function, one or more sub-costs that contribute to the total execution cost based on the bottleneck model, and values of one or more parameters of a solution set that contribute to the one or more sub-costs and/or the total execution cost of the function;
(ii) identifying, for the function, one or more bottleneck-related nodes of the bottleneck cost graph associated with the solution set and the current hardware-software configuration, based on a relative contribution of the one or more sub-costs of the bottleneck cost graph to the total execution cost, each bottleneck-related node of the one or more bottleneck-related nodes being associated with one or more sub-costs of the bottleneck cost graph;
(iii) aggregating, for the plurality of functions of the one or more workloads, one or more candidate values of one or more bottleneck-related parameters of the one or more parameters of the bottleneck cost graph that contribute to sub-costs associated with the one or more bottleneck-related nodes of the bottleneck cost graph, each candidate value of the one or more candidate values being associated with a bottleneck-related parameter of the one or more bottleneck-related parameters;
(iv) updating a value of the bottleneck-related parameter of the solution set to include a candidate value of the one or more candidate values based on one or more constraints associated with joint optimization of the plurality of functions of the one or more workloads; and
(v) producing, based on the solution set, an optimized hardware-software configuration for execution of the one or more workloads by the computing system.

2. The method of claim 1, further comprising:
iteratively repeating steps (i)-(iv) until a stop criterion is reached.

3. The method of claim 1, the one or more workloads including one or more deep neural network models and the computing system including a deep learning accelerator for execution of the plurality of functions of one or more workloads.

4. The method of claim 1, further comprising:
constructing, for execution of a workload of the one or more workloads at the computing system, the bottleneck model expressive of an execution cost hierarchy of the workload in a graphical format for explicit analysis.

5. The method of claim 4, the bottleneck model including:
a root node correlating with the total execution cost associated with the workload;
a branch node represented by a mathematical operator and indicating a sub-cost that contributes to the total execution cost; and
a leaf node representing a value of a design parameter or an execution characteristic that contributes to the sub-cost or the total execution cost.

6. The method of claim 1, further comprising:
calculating, for a node of the bottleneck cost graph, the relative contribution of the node to a sub-cost of the one or more sub-costs or to the total execution cost;
comparing the relative contribution of the node to a contribution threshold; and
identifying, based on comparison of the relative contribution to the contribution threshold, the node of the bottleneck cost graph as a bottleneck-related node of the one or more bottleneck-related nodes.

7. The method of claim 1, further comprising:
accessing, at the processor, design space exploration information about the one or more workloads for execution by the computing system, the design space exploration information including:
information about a design space defining a plurality of parameters to be optimized and corresponding possible values for each parameter of the plurality of parameters for execution of the one or more workloads;
information about one or more optimization objectives associated with execution of the one or more workloads;
information about one or more constraints associated with execution of the one or more workloads; and
information about one or more tasks associated with execution of the one or more workloads.

8. The method of claim 1, the method further comprising:
executing a workload of the one or more workloads at the computing system in communication with a memory hierarchy via networks on chip, the computing system being configured according to the current hardware-software configuration associated with the solution set;
obtaining a set of execution characteristics of the workload according to the current hardware-software configuration associated with the solution set;
determining values of the one or more sub-costs and the total execution cost of the workload based on the set of execution characteristics and based on values of parameters associated with the current hardware-software configuration; and
populating the bottleneck cost graph based on an execution cost hierarchy of the workload represented by the bottleneck model, the bottleneck cost graph including the values of the one or more sub-costs and the total execution cost of the workload under the current hardware-software configuration of the computing system.

9. The method of claim 1, further comprising:
determining, for a bottleneck-related node of the bottleneck cost graph, a scaling factor representing a targeted reduction ratio of the value of a sub-cost associated with the bottleneck-related node;
determining a candidate value of a bottleneck-related parameter associated with the bottleneck-related node based on the scaling factor;
constructing one or more candidate solution sets, each candidate solution set including candidate values of the one or more bottleneck-related parameters associated with the bottleneck-related node that are predicted to reduce the value of the sub-cost associated with the bottleneck-related node based on the scaling factor; and
selecting, from the one or more candidate solution sets, updated values of the one or more bottleneck-related parameters in view of the one or more constraints associated with execution of the one or more workloads.

10. The method of claim 9, the candidate value of the one or more candidate values including:
a predicted value of a number of processing elements of the computing system predicted to reduce a computation time according to the scaling factor.

11. The method of claim 9, the candidate value of the one or more candidate values including:
a required value of off-chip bandwidth predicted to reduce a time taken by off-chip memory accesses according to the scaling factor.

12. The method of claim 9, the candidate value of the one or more candidate values including:
a set of bit-width requirements predicted to reduce a time taken by communication via networks on chip according to the scaling factor, including a predicted networks-on-chip bit width for an operand of a plurality of operands corresponding to the function.

13. The method of claim 9, the candidate value of the one or more candidate values including:
a set of unicast, multicast, or other interconnect link requirements predicted to reduce a time taken by communication via networks on chip of the computing system according to the scaling factor, including a predicted quantity of links for each network on chip corresponding to an operand of a plurality of operands of the function.

14. The method of claim 9, the candidate value of the one or more candidate values including:
a local buffer size requirement of a local buffer private to a processing element of the computing system predicted to reduce a time taken by communication via networks on chip according to the scaling factor, considering possible data reuse, including a total predicted local buffer size for a plurality of operands of the function.

15. The method of claim 9, the candidate value of the one or more candidate values including:
a global scratchpad memory size requirement of one or more global scratchpad memories of the computing system predicted to reduce a time taken by off-chip memory accesses according to the scaling factor, considering possible data reuse, including a total predicted global scratchpad memory size for a plurality of operands of the function.

16. The method of claim 1, further comprising:
displaying, at a display device in communication with the processor, an interface that includes information about the bottleneck model of the one or more workloads;
accessing a bottleneck model input from a user or a design automation tool defining the bottleneck model; and
storing, at a memory in communication with the processor, information about the bottleneck model based on the bottleneck model input.

17. The method of claim 16, further comprising:
storing hierarchy information about one or more nodes of the bottleneck model based on the bottleneck model input.

18. The method of claim 16, further comprising:
storing instructions executable by a processor to determine a candidate value of a parameter associated with a node of the bottleneck model based on the bottleneck model input.

19. A method for adaptive and tightly coupled hardware and software co-design of a workload executable by a computing system, comprising:
executing, at a computing system in communication with a memory hierarchy via networks on chip, a workload including a plurality of operations for execution using a deep neural network model under a current hardware-software configuration of the computing system;
iteratively applying, at a processor in communication with the computing system, an optimization methodology for optimization of execution of the workload at the computing system, including:
applying a bottleneck analysis methodology for finding bottlenecks in execution of plurality of operations of the deep neural network model; and
applying a bottleneck mitigation methodology that modifies the current hardware-software configuration of the computing system to satisfy a set of constraints for design and execution of the workload, including a total power consumption, chip area, throughput, energy consumption, and latency; and
producing an optimized hardware-software configuration for execution of the workload by the computing system.

20. A method for developing bottleneck models for analysis of execution of a workload at a deep learning accelerator, comprising:
executing, at a deep learning accelerator in communication with a memory hierarchy via networks on chip and based on a current hardware-software configuration of the deep learning accelerator, a workload including a plurality of operations of a deep neural network model;
applying, at a processor in communication with the deep learning accelerator, a bottleneck analysis methodology to the deep learning accelerator based on execution of the workload, including:
obtaining, at the processor, a set of execution characteristics based on application of one or more analytical models of costs of executing a deep neural network model on a deep learning accelerator under the current hardware-software configuration;
constructing, at the processor and based on a set of accelerator design parameters and execution characteristics obtained, a bottleneck cost graph representing execution costs of the workload at the deep learning accelerator under the current hardware-software configuration; and
determining, at the processor and based on the bottleneck cost graph, a scaling factor of a value of a bottleneck-related parameter of the current hardware-software configuration predicted to improve execution efficiency of the workload by the deep learning accelerator; and
producing, based on the scaling factor, an optimized hardware-software configuration for execution of the workload by the deep learning accelerator.

21. A system, comprising:
a processor in communication with a memory, the memory including instructions executable by the processor to:
(i) construct, at the processor and for a function of a plurality of functions of one or more workloads for execution by a computing system, a bottleneck cost graph corresponding to a bottleneck model for the function based on a current hardware-software configuration of the computing system, the bottleneck cost graph representing a total execution cost of the function, one or more sub-costs that contribute to the total execution cost based on the bottleneck model, and values of one or more parameters of a solution set that contribute to the one or more sub-costs and/or the total execution cost of the function;
(ii) identify, for the function, one or more bottleneck-related nodes of the bottleneck cost graph associated with the solution set and the current hardware-software configuration, based on a relative contribution of the one or more sub-costs of the bottleneck cost graph to the total execution cost, each bottleneck-related node of the one or more bottleneck-related nodes being associated with one or more sub-costs of the bottleneck cost graph;
(iii) aggregate, for the plurality of functions of the one or more workloads, one or more candidate values of one or more bottleneck-related parameters of the one or more parameters of the bottleneck cost graph that contribute to sub-costs associated with the one or more bottleneck-related nodes of the bottleneck cost graph, each candidate value of the one or more candidate values being associated with a bottleneck-related parameter of the one or more bottleneck-related parameters;
(iv) update a value of the bottleneck-related parameter of the solution set to include a candidate value of the one or more candidate values based on one or more constraints associated with joint optimization of the plurality of functions of the one or more workloads; and
(v) produce, based on the solution set, an optimized hardware-software configuration for execution of the one or more workloads by the computing system.
